(19) United States
(12) Patent Application Publication
(10) Pub. No.: US 2019/0206070 A1
(43) Pub. Date: Jul. 4, 2019

(54) IMAGE REGISTRATION METHOD

(71) Applicant: Auckland UniServices Limited, Auckland (NZ)

(72) Inventors: Martyn Peter Nash, Mt. Albert (NZ); Poul Michael Fonss Nielsen, Epsom (NZ); Amir Haji Rassouliha, Grafton (NZ); Andrew James Taberner, Mt. Eden (NZ)

(21) Appl. No.: 16/302,661

(22) PCT Filed: May 18, 2017
(86) PCT No.: PCT/NZ2017/050064

§ 371 Date: Nov. 18, 2018

(30) Foreign Application Priority Data
May 18, 2016 (NZ) 720269

(51) Int. Cl. G06T 7/37; G06T 5/00; G06T 5/20; G06T 5/50; G06T 7/32; G06T 7/33

(52) U.S. Cl. CPC G06T 7/37; G06T 5/002; G06T 7/33; G06T 5/50; G06T 7/32; G06T 5/20

(57) ABSTRACT

The present invention relates to an image registration method, in particular it relates to an image registration method in for identifying translational shifts between images or signals of arbitrary dimension. The method for registering a plurality of images described herein comprises: obtaining a frequency domain representation of one or more spatial domain or frequency domain functions or filters or kernels, wherein each function emphasises at least one image characteristic; combining functions into a single frequency domain representation function; and applying the combined frequency domain representation function to the images to determine relative displacement. In another aspect, the method for registering a plurality of images also comprises: applying functions to calculate shifts between images; applying phase unwrapping technique to exclude phase data outliers; and employing phase data to calculate subpixel shifts between the images.

### FIELD OF THE INVENTION

The present invention relates to an image registration method, in particular it relates to an image registration method for identifying translational shifts between images or signals of arbitrary dimension.

### BACKGROUND

Several methods have been proposed to register two-dimensional (2D) or three-dimensional (3D) images. Image registration techniques are widely used in various areas. Subpixel image registration and subpixel deformation measurement are of particular interest in applications where accurate registration of the images, or precise measurement of small deformations, is required, such as motion estimation and tracking, image alignment, medical image processing, super-resolution reconstruction, image mosaicking, satellite image analysis, and change detection. Subpixel image registration techniques are also used for surface inspection, deformation measurement, and strain measurement in industrial and medical applications.

In general, image registration techniques are required when multiple images of a scene or object are acquired at different times, and/or from different locations. A challenge is to transforming the images such that they are in the same coordinate system. This enables comparison between, or integration of, the data from the different images. The differences between the images may be transformations including translation, rotation, scaling, or other, more complicated, transformations.

Two main approaches are available for subpixel image registration. In the first approach, integer and the subpixel/subvoxel shifts are found in two separate steps (i.e. two-step methods). The second main approach treats the registration as a cost function, and the subpixel shift is found using an iterative error minimisation process based on methods such as Newton-Raphson (NR) and gradient-based (GB) methods. Many of the methods that register images to subpixel accuracy are two-step methods. The most common method of finding the integer shift is to find the peak in the cross-correlation (CC) or normalised cross-correlation (NCC) of the two images. The subpixel/subvoxel shifts are found by various methods, such as upsampling in the spatial domain or the frequency domain, fitting to a function, using phase-based methods, and using iterative methods and shape functions.

Digital image correlation (DIC) is the best known two-step method for finding subpixel deformations in images. DIC has many applications, including 2D surface deformation measurement for anisotropic elastic membranes, finding strain fields in human tendon tissue, measuring 3D movements of rotary blades, and 3D deformation quantifying during metal sheet welding. The DIC technique can measure 2D and 3D surface deformations, and volumetric deformations. The following sections describe these techniques.

### 2D and 3D DIC

Current 2D/3D DIC techniques have a number of problems. For example, if we consider the problem of finding the integer shift, cross-correlation (CC) is not sufficiently accurate, and normalised cross-correlation (NCC) is computationally intensive. Phase-correlation (PC) is another method for finding integer shifts, based on the Fourier shift property and normalised cross power spectrum. PC is more robust to noise and uniform changes in the intensity, and has been shown to perform better than CC but does not have sufficient accuracy or computational efficiency. Gradient-correlation (GC) and normalised GC (NGC) methods use a complex value (real and imaginary values), based on a central differences approximation for each pixel, instead of the intensity values in the CC function.

The subpixel shift between two images may be found by a number of methods. For example interpolation in the spatial domain is sometimes used, but it is typically computationally intensive. To address this issue, interpolation in the frequency domain (FFT-upsampling) has been proposed. However, the accuracy of this method is limited by the upsampling ratio as well as the interpolation method, and is slow for large upsampling ratios. Curve fitting may be used to numerically fit functions near the peak of the CC or GC function to find the subpixel shift. Examples of functions include Gaussian, quadratic, and modified Mexican hat wavelet. However the accuracy of these methods is dependent on the CC or GC function shape. A further drawback is that these methods usually contain a time-consuming iterative optimisation process to find the best fit.

Another technique is to use a phase-based approach, based on the Fourier frequency shift theorem and the slope of the phase difference of intensity values of the two images. In this method, phase unwrapping is necessary for shifts larger than one pixel. Previous techniques have first determined the integer shift and then used 2D regression on the phase difference data to find the subpixel shift. This method is sensitive to aliasing and requires that the images be registered to within half a pixel at the first step. Further techniques in DIC and experimental mechanics use iterative methods such as NR and GB for measuring the subpixel displacements. These have high computation costs and are therefore slow. Because they are based on the differences in intensity values, the methods are sensitive to intensity changes, making them suitable for small shifts only. This is a significant restriction for many applications. In addition, each subset deformation in the iterative NR method involves interpolation, which introduces additional systematic errors.

### Volumetric Deformations

Digital volume correlation (DVC) (also known as volumetric-DIC) is an extension of DIC for measuring 3D subvoxel deformations (or displacements) in volumes. DVC has been used to quantify displacements of human soft tissues, such as the brain, to inform computational models. Furthermore, DVC is an essential part of a widely used technique to assess the structural and mechanical behaviour of materials, in which the test material is deformed under an applied force while a device records images before and during the deformations. X-ray computed tomography (CT) is the most common imaging modality used to capture volumetric deformations. For example, the DVC technique has been applied to X-ray CT or micro-CT images to assess the mechanical behaviour of foams [13], composites, bones, scaffold implants, polymer bonded sugars, and bread crumbs. The DVC technique was also used to study crack initiation and propagation in X-ray CT and synchrotron radiation laminography images, and to measure thermal properties in X-ray CT images. However, the use of DVC in low-quality 3D imaging technologies is restricted because of the limitations of current DVC techniques. For instance, DVC was used for the first time in 2013 to measure elastic stiffness from optical coherence tomography (OCT) images.

Sutton and Hild summarised some of the challenges of current DVC techniques in a recent paper, including: performing accurate grey level interpolations; selecting a suitable shape function; and processing the enormous amount of data in a short time. Furthermore, DVC algorithms require a good initial estimate of the parameters. These challenges arise from the inherent limitations of the existing techniques used for DVC. Most of the existing DVC techniques use the 3D-CC of volumes to find the integer shift and an iterative nonlinear optimisation to find the subvoxel shifts. The computational costs of DVC algorithms are G×S times greater than 2D-DIC algorithms for grid point spacing of G pixel (voxel) and a subset size of S pixel² (voxel³) over the image (inside the volume), and are thus slow. For example, previously a parallel computing architecture with 8 processors could only reduce the computation time from 45.7 hours to 5.7 hours to compute a DVC of size 41 voxel×41 voxel×41 voxel in a grid consisting of (39×39×39) points. This limitation becomes more problematic for high-resolution images and for large amounts of data. Furthermore, the CC used in the DVC algorithms is sensitive to noise and changes in the image illumination, and fails with images that have poor texture or have undergone large deformations. Thus, the use of DVC was limited to measuring small deformations in rich-textured volumes. To improve registration, CC was replaced with NCC in some methods. However, although NCC has some advantages over CC in dealing with changes in image illumination, it does not address several other limitations of CC. For instance, NCC is substantially more computationally demanding than CC, and it performs poorly with large deformations. Pan et al. (Pan, B., Yu, L., Wu, D. High-accuracy 2D digital image correlation measurements using low-cost imaging lenses: implementation of a generalized compensation method. Measurement Science and Technology, (2014), 25:2) addressed the latter limitation by proposing an incremental DIC method to update the reference image to measure large deformations, but their method considerably increased the computation time.

The limitations of CC and NCC have been addressed by some 2D methods, such as gradient-correlation (GC), and phase-correlation (PC). GC combines the central differences of intensity values in the two coordinate directions to form a single complex image by multiplying one real subimage by i=\sqrt{−1} and adding it to the other real subimage. This approach allows the information in two real values to be encoded as a single complex value. PC uses the normalised cross-power spectrum of the intensities of two images to find their relative shift. Since PC and GC do not directly use the intensity values of the images, they are both more robust than CC at finding shifts in images with poor texture. GC was later also used in 2D subpixel registration algorithms.

Some approaches were proposed to address the shortcomings of CC and NCC in DVC applications where the test volume had large deformations. A stretch-correlation method was proposed in the past to address the limitations of DVC in measuring large deformations. Stretch-correlation was implemented in the Fourier-domain using the fast Fourier transform (FFT) of the volumes. Stretch-correlation takes the stretch of subimages into consideration in a polar coordinate system by decomposing the deformation gradient tensor into the orthogonal rotation and the symmetric right-stretch tensors, assuming small rotations and shears. However, the stretch-correlation method can only improve the registration performance in large deformations where the volume is stretched, not when subimages are displaced or shifted. Recently, Bar-Kochba et al. (Bar-Kochba, E., Toyjanova, J., Andrews, E. A Fast Iterative Digital Volume Correlation Algorithm for Large Deformations. Experimental Mechanics, 2015, 55: 261) proposed an iterative DVC approach and a weighting function for CC coefficients to measure large deformations. The method of Bar-Kochba et al. used an approach similar to that proposed by Pan et al. for 2D applications, which was to start with a large subimage, measure the deformations, warp the two volumes, measure the error between the volumes, and decide based on an error threshold whether to continue to another iteration with a smaller subimage or to stop the process. The purpose of using a weighting function in the method of Bar-Kochba et al. was to increase the resolution of displacement fields by weighting the high frequencies. The weighting function of the method of Bar-Kochba et al. was adapted from the method of Nogueira et al. (Nogueira, J., Lecuona, A., Ruiz-Rivas, U., Rodriguez, A. Analysis and alternatives in two-dimensional multigrid particle image velocimetry methods: application of a dedicated weighting function and symmetric direct correlation. Measurement Science and Technology, 2002, 13 963-74), which was proposed for particle image velocimetry. identified and removed the outliers from the CC output at each iteration, and found subvoxel shifts in their method by fitting a bivariate Gaussian function to the peak of the final cross-correlation output. Although using the weighting function in the iterative method of Bar-Kochba et al. [34] improves the performance of CC at large shifts, it cannot eliminate the low-pass behaviour of the CC. Furthermore, the approach of Bar-Kochba et al. [34] is a computationally intensive iterative process.

Another method using a volume gradient correlation was proposed to overcome the shortcomings of CC when performing 2D-3D registrations between low-contrast images and 2D projected volumes. Gradient correlation uses the mean of the NCC values of two coordinates of the gradient images of 2D projected volumes. Volume gradient correlation was shown to perform better than NCC for 2D-3D registration in medical images, and was able to register clinical 3D CT data to 2D X-ray images where CC failed. Even though volume gradient correlation performs better than CC and NCC in low-contrast applications, it is only applicable in 2D cases, and cannot be used for DVC. However, dealing with low-contrast volumes is a big challenge in DVC applications, since it is difficult to increase the contrast by adding a random speckle pattern, as is performed in 2D cases.

Hence, the current art does not provide suitable levels of accuracy, speed, robustness to noise, and/or computational efficiency for many 2D/3D applications, including in low texture images. A particular problem is that the accuracy of the methods is not sufficient to allow highly accurate subpixel registration in many applications.

### OBJECTS OF THE INVENTION

It is an object of the invention to provide an image registration method which will increase the efficiency, and/or accuracy, and/or robustness of prior systems. The image registration method may be applicable for images of arbitrary dimension.

It is an object of the invention to provide an image registration method, which will at least go some way to overcoming disadvantages of existing systems, or which will at least provide a useful alternative to existing systems.

It is a further object of the invention to provide an image registration method with subpixel accuracy, which will at least go some way to overcoming disadvantages of existing systems.

Further objects of the invention will become apparent from the following description.

### SUMMARY OF INVENTION

Accordingly in a first aspect the invention may broadly be said to consist in an image registration method between a plurality of images of arbitrary dimension. This method is a two-step method that improves the accuracy, speed, and robustness of finding shifts both in the integer and subpixel parts, compared to the existing methods. In the integer part, filters are applied to images to emphasise image information and decrease the effect of noise. In the subpixel part, methods were proposed to decrease the effect of noise and spurious frequency components in the phase-based methods of finding subpixel shifts. The method is first described in a broad form and then a specific 2D implementation is described.

The Broad Form of the Image Registration Method

The invention may broadly be said to consist in an image registration method between a plurality of images of arbitrary dimension, the method comprising the step of:

Obtaining the frequency domain representation of one or more filter functions, wherein each filter function emphasises at least one image characteristics. A characteristic may be reduced noise or improved signal to noise ratio.

In an embodiment the filter functions are defined in the spatial domain as kernels. In an embodiment the method includes the step of taking a Fourier transform of the filter function.

In an embodiment the filter functions are combined to form a single function. In an embodiment the combination comprises the step of multiplication in the frequency domain.

In an embodiment the method includes the step of squaring the filter functions.

In an embodiment the method comprises the step of obtaining a Fourier domain cross-correlation of the plurality of images.

In an embodiment the method comprises the step of forming a filtered cross-correlation (FCC) by combining the squared filter functions and the Fourier domain cross-correlation of the plurality of images.

In an embodiment the images have one, two, three or more dimensions.

In an embodiment the one or more filter functions used in the FCC have a plurality of dimensions. Preferably the filter functions have the same number of dimensions as the image.

In an embodiment the method includes the step of weighting the FFC values.

In an embodiment the method includes the step of obtaining the magnitude of the Fourier domain filtered cross-correlations. In an embodiment the magnitude is used to find the maximum peak.

In an embodiment the integer shift is used to register two images within less than one pixel.

In an embodiment the subpixel shift is calculated using the phase difference data of the images that were registered using the integer shift value found in previous steps.

In an embodiment the filter functions used in the FCC comprise differentiation kernels to extract the intensity gradients and a smoothing function to reduce the effects of noise.

In an embodiment the filter function is applied in the Fourier domain. In an embodiment the system comprises a plurality of different kernels/functions.

Preferably the frequency domain representations of the filter functions used in the FCC are precalculated.

Accordingly in a further aspect the invention may broadly be said to consist in an image registration method between a plurality of images, the method comprising the steps of:
Obtaining a frequency domain representation of a function (filter);
Applying the frequency domain representation of the function (filter) to a frequency domain representation of a cross-correlation.

In an embodiment the step of obtaining a frequency domain representation comprises taking the Fourier transformation from a time- or space-domain function (filter).

Preferably the function is one of a plurality of possible filter functions.

Preferably the method comprises the step of selecting a function from a plurality of precalculated functions.

Preferably the method comprises the step of repeating the method with a second, or a plurality of different functions.

Preferably the function may further comprise a smoothing and/or differentiation function.

Preferably the smoothing function comprises a smoothing kernel. Preferably the smoothing function reduces the effects of noise. Preferably the smoothing function comprises at least one shape preserving characteristic.

Preferably the method is applied to a plurality of images and the precalculated smoothing function is reused.

Preferably the frequency domain representation further comprises a differential operation. Preferably the differential operation or operator emphases and/or extracts at least one of the image features.

Preferably the frequency domain representation of the smoothing filter is modified before being applied to the cross-correlation. Preferably the modification is dependent on the image contents.

Preferably the frequency domain representation of the smoothing filter comprises a weighting profile. In an embodiment the method includes the step of weighting the frequency domain representation.

Preferably the weighting profile is a squared value. In an embodiment the output of the filtered cross-correlations is weighted before calculating the total filtered-cross-correlation (FCC).

Preferably the method comprises the step of obtaining a frequency domain representation of a smoothed cross-correlation by applying the frequency domain representation of the smoother function to the representation of a cross-correlation.

Preferably the application comprises a multiplication of the representations.

Preferably the cross-correlation comprises the cross-correlation of the plurality of images calculated, at least in part, by a multiplication of the complex conjugate of a first and second image.

Preferably the method comprises the step of applying a window function to at least one of the plurality of images.

Preferably at least one of the frequency domain representations is a Fourier representation.

Preferably the plurality of images comprises two or more subimages.

Preferably the method includes the step of applying a frequency domain transform to a representation of the plurality of images.

Preferably the method comprises the step of calculating a spatial domain representation of the frequency domain representation of the smoothed cross-correlation.

Preferably the method comprises the step of combining a plurality of spatial domain representations as a vector valued image.

Preferably the method includes the step of estimating a relative displacement between two images.

Accordingly in a further aspect the invention may broadly be said to consist in an image registration method between a plurality of images, the method comprising the step of obtaining a filtered cross-correlation (FCC) between the plurality of images in the frequency domain to find the integer shift.

In an embodiment the image registration method includes the step of applying filters that extract or emphasise image features and/or reduce the effects of noise, such as a smoothing differentiator kernel.

Preferably the step of obtaining the filtered cross-correlation (FCC) comprises multiplying one or more filter functions with a cross-correlation on the plurality of images.

Preferably the one or more filter functions are precalculated.

Preferably the filter function is a smoothing differentiator function.

Preferably the method comprises the step of obtaining a filtered cross-correlation representation in the time or spatial domain.

Preferably the method comprises the step of obtaining an estimate of the relative integer displacement between the images from the output of filtered cross-correlation (FCC) in the frequency domain.

Preferably the effects of noise and aliasing were removed from the phase data in the subpixel part.

Accordingly in a further aspect, the invention may broadly be said to consist in an image registration method between a plurality of images, the method comprising the steps of: Obtaining an image characteristic at a plurality of points in each image;
Apply a filter/kernel to the images. This could compromise a smoothing gradient filter.

Accordingly in a further aspect the invention may broadly be said to consist in an image registration apparatus comprises:
An imager for obtaining a plurality of images;
An output for displaying or storing registered images; and
A processor for registering the plurality of images;

Wherein the processor applies the method as described in any one or more of the above aspects or embodiments.

The invention may also consist in an image registration method or apparatus as set forth in any one of the appended claims.

An Embodiment of the Image Registration Method for 2D Image Registration

The invention provides a more accurate 2D pixel translation shift. This is achieved by the calculation of a gradient combining multiple neighbouring points of the gradient measurement. The process may also involve the application of a feature extracting function, such as a smoothing function. This may be combined (or include) with a further operator for extracting or emphasising some of the image characteristics, such as a differentiator kernel (gradient). Although the gradient appears to be a minimal factor in the calculation and a more complex, or higher order function increases the computational load, the addition of a smooth gradient, or a smoothing filter combined with a differentiator kernel, has a large beneficial impact on the image registration.

In an embodiment the gradient estimate further comprises an operator. In an embodiment the operation emphasises at least one of the image characteristics.

In an embodiment the feature extracting function comprises a smoothing function.

In an embodiment the image characteristics is intensity.

In an embodiment the step of obtaining the image characteristics may be through extraction.

In an embodiment a set of image characteristics may be obtained.

In an embodiment the characteristics may be extracted in a plurality or all of the dimensions of the image.

In an embodiment the feature extracting function comprises at least one shape preserving characteristic.

In an embodiment the shape preserving characteristic removes noise while minimally changing the underlying true values.

In an embodiment the feature extracting function comprises at least one denoising characteristic.

In an embodiment the gradient estimate has a noise reduction property.

In an embodiment the smoothing function is based on fitting the gradient to a polynomial

In an embodiment the feature extracting function is applied to the images in the frequency domain.

In an embodiment the gradient comprises a plurality of gradient values.

In an embodiment the fitting means is running least-squares.

In an embodiment the frequency response of the smoothing function has a required shape.

In an embodiment the feature-extractor function has a required shape.

In an embodiment the smoothing function and/or feature-extractor function are implemented using a convolution kernel. In an embodiment the feature extractor function is a filter.

In an embodiment the smoothing function and/or feature-extractor function are implemented in hardware.

In an embodiment the gradient estimate uses a Savitzky-Golay Differentiator.

In an embodiment the plurality of points represent pixels of an image.

In an embodiment the smoothing function is applied to the rows and columns of the image or image representation. In an embodiment the smoothing function is applied to a plurality, or all, of the dimensions of the image or image representation.

In an embodiment the gradient is estimated in a plurality, or all, dimensions of the image. In an embodiment the dimensions are orthogonal directions.

In an embodiment the feature-extractor function is applied to a plurality or all dimensions of the image. In an embodiment this is in the frequency domain.

In an embodiment the method comprises the step of obtaining the plurality of images.

In an embodiment the images are obtained by a camera or video camera. In an embodiment the images are obtained from an imaging system (for instance MRI, CT-Scan, satellite, camera or video camera)

In an embodiment the method comprises the step of transforming the images into the frequency domain. Preferably the transformation is from the spatial domain. Preferably a Fourier transform is used. In an embodiment the images are transformed into the frequency domain, manipulated and inversed transformed from the frequency domain to find the shift between them.

In an embodiment the method includes the step of calculating a cross correlation. In an embodiment the cross correlation is normalised.

In an embodiment the method calculated a cross-correlation.

In an embodiment the method includes the step of applying a window function. Preferably the window function preserves the high-frequency information of the image

In an embodiment the method calculates integer pixel shift.

In a further aspect the invention may broadly be said to consist in an image registration method between a plurality of images, the method comprising the steps of:

Obtaining an image characteristic at a plurality of points in each image;

Estimating the gradient of the image characteristic, the gradient estimate comprising a shape preserving function.

The invention provides a more accurate pixel translation shift. This is achieved by the calculation of a gradient combining multiple neighbouring points of the gradient measurement. Although the gradient appears to be a minimal factor in the calculation and a higher order function increases the computational load the addition of a shape preserving gradient estimate creates an accurate gradient estimate and removing noise. Preferably the shape preserving function removes noise and minimally changes the underlying true values. In a further aspect the invention may broadly be said to consist in an image registration method between a plurality of images, the method comprising the steps of:
Obtaining an image characteristic at a plurality of points in each image;
Obtaining a noise characteristic of the image characteristic;
Selecting a sample size based on the noise characteristic; and
Calculating a gradient of the image characteristic based on the image characteristic data within the sample size.

In an embodiment the image characteristic for subpixel shift estimation is a phase difference.

In an embodiment the phase difference is a phase difference between two images.

In an embodiment the noise characteristic is standard deviation.

In an embodiment the noise cancellation is the standard deviation of phase difference data.

In an embodiment the method includes the step of filtering the image characteristic in the within the sample size.

In an embodiment the step of filtering removes high frequency noise.

In an embodiment method includes the step of filtering the image characteristic in the within a feature size.

In an embodiment the sample size selection is adapted based on an equation which comprises a noise characteristic.

In an embodiment the method comprises the step of filtering the phase difference to smooth the phase difference data.

In an embodiment the method comprises the step of filtering the phase difference to remove spurious frequencies.

In an embodiment the filter is a median filter. In an embodiment the filter is a 2D median filter.

In an embodiment the method determines a subpixel shift.

In an embodiment the second aspect is combined with the first aspect.

In an embodiment the sample size is a phase data size.

In a further aspect the invention may broadly be said to consist in an image registration method between a plurality of images, the method comprising the steps of:
Obtaining an estimate of the integer pixel-shift between the images;
Obtaining an estimate of the subpixel shift between the images;

Wherein the subpixel shift is calculated using images less than 1 pixel apart.

Assuming, or using images that are less than 1 pixel apart reduces the complexity of the subpixel calculation because, for example, the image phase does not need to be unwrapped before processing. This provides cleaner and clearer data for calculation of the subpixel shift.

In an embodiment the subpixel shift is calculated without first unwrapping the phase data.

In an embodiment the images are assumed to be less than one pixel apart.

In an embodiment the step of obtaining an estimate of the subpixel shift between the images comprises the step of shifting one of the images by the obtained integer pixel shift.

In an embodiment the integer pixel-shift and subpixel shift are any one of the embodiments described herein.

In a further aspect the invention may broadly be said to consist in an image registration method between a plurality of images, the method comprising the step of:
Normalising a plurality of image characteristics by subtracting an offset value and dividing by a maximum value.

Preferably the offset value is a mean value of the image characteristic.

Preferably the mean value is the mean DC value.

Preferably the maximum value is the maximum value of the image characteristic.

The preferable features described above should be considered, when possible, to be applied to any of the described aspects.

The disclosed subject matter also provides an arbitrary dimensional image registration method which may broadly be said to consist in the parts, elements and features referred to or indicated in this specification, individually or collectively, in any or all combinations of two or more of those parts, elements, or features. Where specific integers are mentioned in this specification which have known equivalents in the art to which the invention relates, such known equivalents are deemed to be incorporated in the specification.

Further aspects of the invention, which should be considered in all its novel aspects, will become apparent from the following description.

### DRAWING DESCRIPTION

A number of embodiments of the invention will now be described by way of example with reference to the drawings in which:

FIG. 1 is a flow chart of an embodiment where cross-correlation is used to identify a pixel shift using a two stage method in the 2D form of the invention.

FIG. 2 is a flow chart of an embodiment where SGD is used to identify an integer pixel shift in the 2D form of the invention.

FIG. 3 is a flow chart of an embodiment where a 2D regression of the phase difference details used to identify a subpixel shift in the 2D form of the invention.

FIG. 4 is a plot of the frequency response characteristics of central differences and a 7 point cubic first derivative Savitzky-Golay interpolation in the 2D form of the invention.

FIG. 5 is a 2D heatmap of the power spectrum of a sample image (FIG. 9a) for (a) for the original image and (b) with addition of a small amount of white Gaussian noise, showing the distribution of noise versus fine image details in high frequency components.

FIG. 6 shows the frequency response of Hamming, Hann, Blackman, and Tukey (a=0.25) window functions.

FIG. 7 is a diagram of the normalisation procedure in the 2D form of the invention.

FIG. 8 shows standard LANDSAT images for image registration.

FIG. 9 shows diagrams of (a) The central points of sub-images on the LANSAT image of Paris. (b) A sample sub-image (128 pixel×128 pixel).

FIG. 10 are plots of an embodiments of: (a) The average registration error (pixel) in estimating the shift in 400 sub-images of the LANDSAT image of Paris (128×128 pixel) for our method and an existing method; (b) The average number of points with normalised SGGC values (9) greater than 0.85 as the error metric of the integer part of our method; and (c) The plane fitting error to phase difference data as the error metric of an embodiment.

FIG. 11 shows images showing (a) LANDSAT image of Paris (b) LANDSAT image of Paris with Gaussian noise added FIG. 12 shows heat maps of (b) the ideal rotation pattern of a 1° rotation for the same size image. Rotation patterns were found by using our method (c), an existing method; and (a) Displacement vectors determined using the 2D form of the invention for the rotation about the centre of the LANDSAT image of Mississippi.

FIG. 13 shows a flow chart of an embodiment of the 2D form of the invention.

FIG. 14 shows a flow chart an embodiment of the invention for finding integer shifts in the 2D form of the invention.

FIG. 15 shows a flow chart of an embodiment of the broad form of invention for finding integer shifts.

FIG. 16 shows a flow chart of a second embodiment of the broad form of invention for finding integer shifts.

FIG. 17 shows a flow chart of a third embodiment of the broad form of invention for finding integer shifts.

FIG. 18 shows a flow chart of an embodiment of the broad form of invention for finding subpixel shifts.

FIG. 19 shows a flow chart of a second embodiment of the broad form of the invention for finding subpixel shifts.

FIG. 20 shows a flow chart of a third embodiment of the broad form of the invention for finding subpixel shifts.

FIG. 21 a, b and c. show plots of the efficiency of embodiments of the method.

FIG. 22 shows a schematic diagram of an image registration method.

### DETAILED DESCRIPTION OF THE DRAWINGS

Throughout the description like reference numerals will be used to refer to like features in different embodiments.

In an example embodiment image registration may be used in medical fields. For instance the system may be used to evaluate the fluctuations or distension of the jugular vein on the neck. A stereoscopic system using two cameras can be used to monitor the vein in 3D without contact. Although a stereoscopic system is described further cameras or image sources may be used. In a proposed method a light image is projected onto a person's neck. Because two cameras are used a 3D image can be formed through the combination of these. However it is important that images obtained from either or both cameras are correctly aligned for comparison of any differences between images over a period of time. For instance if there is movement of a user's neck during a measurement the system must be able to estimate the movement, so the vein movement can be distinguished from the patient movement.

More broadly the images may be compared to look for differences in the same type of images taken at different times. For instance, mapping a location pre and post the use of a contrast agent (such as in techniques for MRI with tracers, of angiography with markers). In a second example image registration can map structural changes, such as tumour growth, or degenerative diseases.

In yet further examples, the image registration of the invention can be used to detect changes in function, such as functional MRI with brain stimulus, or PET imaging with tracers.

In general, image registration can be used in a system which is taking a photo or otherwise obtaining an image and the patient (or other object) cannot be suitably fixed in position.

In further examples, the image registration of the invention can be used to relate information from different image sources. This may be through different apparatus used to obtain the images, or relating different measurements taken by the same, or different, machines. The images may be obtained by an imager or an image input means operating in 2, 3, or many dimensions. For example the imager/image input means may be a camera, or an MRI machine, or an x-ray machine.

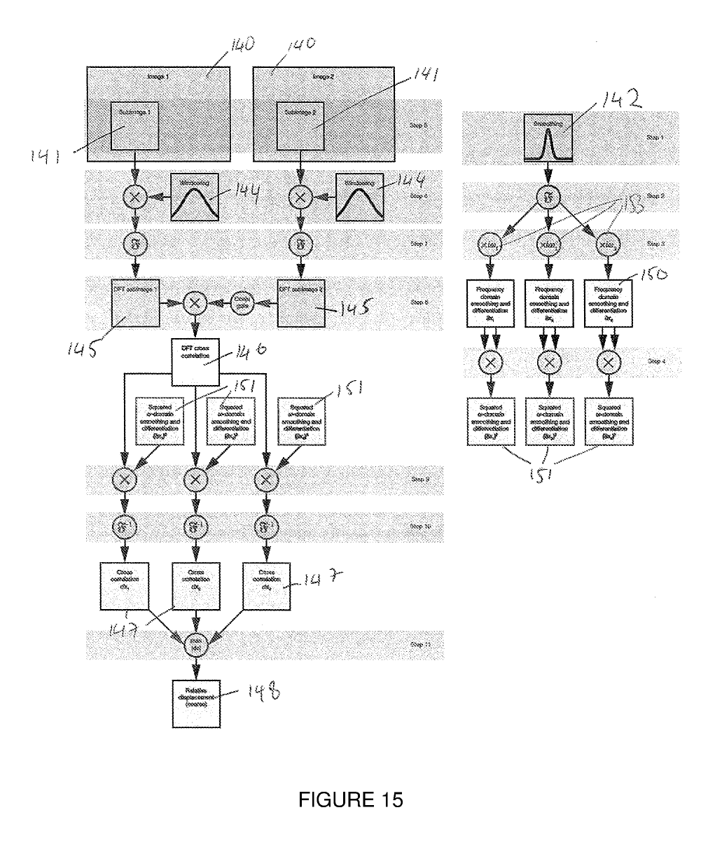

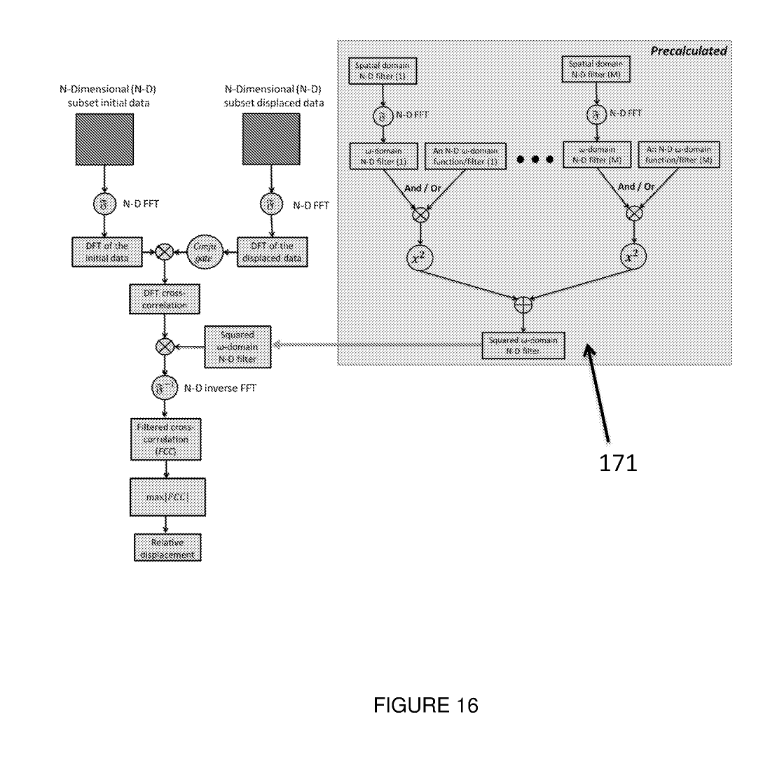

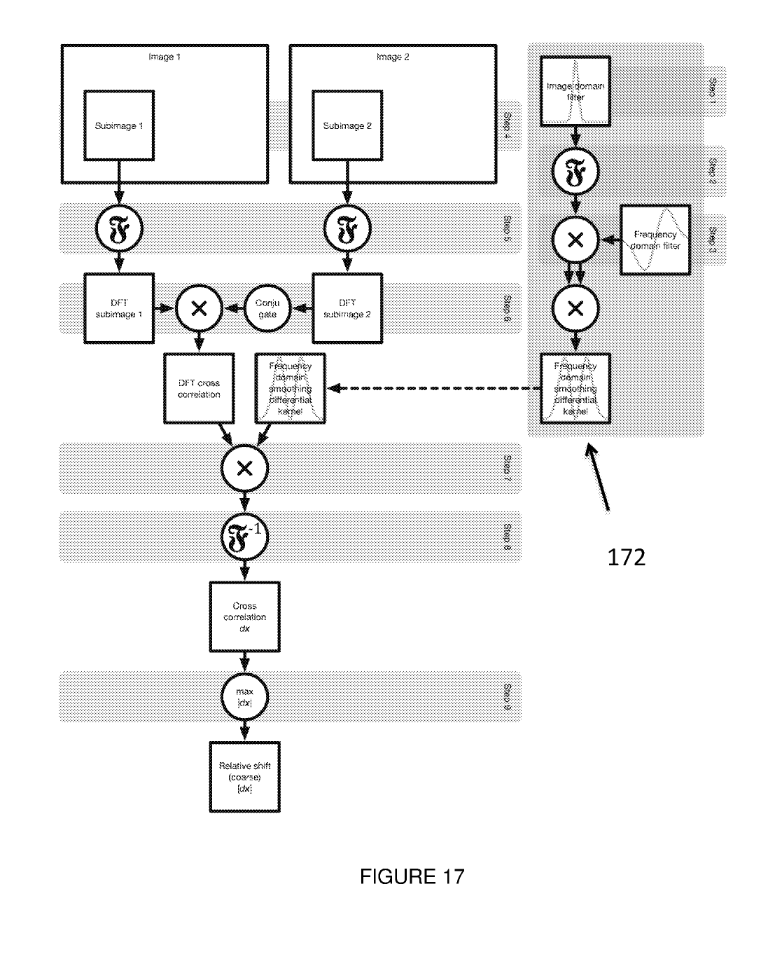

FIG. 15, FIG. 16, and FIG. 17 show alternative embodiments of the broad form of the invention in which the workflow of the method is adapted to allow, at least, a separate calculation of the smoothing function 142 in 3 (FIG. 15) or any number of filters of arbitrary dimensions in (FIG. 16) and a smoothing differentiator kernel of arbitrary dimensions in FIG. 17). The smoothing function 142 in FIG. 15, Filters (171) in FIG. 16, and the smoothing differentiator kernel (172) in FIG. 17 can be chosen by acquiring knowledge of the particular images or subimages, or a generic smoothing function can be chosen. A frequency transform is applied (e.g. a DFT) to produce a frequency domain representation equivalent to the dimensions of a subimage. The frequency domain representation of the smoothing function can then be multiplied by a differentiation operator i(wₖ)) 153 to obtain an equivalent to the gradient of the smoothing function in each direction vector 143. Although the smoothing and differentiator actions have been shown separately, if a smoothing differentiator (such as Savitzky-Golay) is chosen these can be combined into a single step (172 in FIG. 17). Because large support is available, the exact differential operator may be applied instead of an approximation of the function in the spatial domain. However, approximations can also be implemented if desired. Preferably the direction vectors in FIG. 15 are the image coordinates, although other directions may also be used. The frequency domain representation of the smoothing function and the differentiator function can then be operated on by a weighting profile (e.g. by being squared 151), so as to emphasis particular image characteristics. For instance the effects of differentiation 151 and squaring are to emphasise high spatial frequency image features relative to low spatial frequency features by a factor of (wₖ)². Any combinations of spatial domain or frequency domain filters can be designed and used in 171 in FIG. 16. N-D Savitzky-Golay filters are an example of a spatial domain filter that can be used in 171 in FIG. 16.

The described calculation of the frequency domain representation 151 in FIG. 15, 171 in FIGS. 16, and 172 in FIG. 17 does not require the use of the subimages themselves. Therefore, these steps can be performed before the calculation of the subimages. The precalculation of these terms allows a plurality of possible functions or filters to be calculated and stored for future use. This allows, for example, a plurality of possible smoothing functions to be used, or efficient testing of different smoothing functions. This separation or decoupling of the smoothing and differential operations in FIG. 15 also reduces the computational burden of using a smoothing function or filter kernels with large supports. This is because it does not have to be recalculated for each subimage. In the above method the smoothing and differential operations are decoupled into separate steps, using the exact frequency domain first differential operator to overcome the artefacts, which are caused by the spatial domain representation of the differentiator. Artefacts may include ripples, or limited frequency band response. The frequency domain representation of the smoothing differentials could alternatively be calculated directly by applying the discrete Fourier transform to smoothing differential kernels (e.g. the Savitzky-Golay smoothing differentiator).

In embodiments of the method may comprise a feature-extractor function or filter in FIG. 16 and FIG. 17. The feature extractor function incorporates or includes, be assisted by, be a part of, or replace the smoothing function. The filter extractor function emphasises image information (useful for image registration) while reducing the impact of non-information components (such as noise and drift). The methods, or best filter, for achieving the best relationship will depend on the spatial and frequency characteristics of the image. In some embodiments the relationship can depend on the characteristics of a subimage, wherein the filter can be updated for different subimages of the image. In typical embodiments the feature-extractor filter is a band-pass filter to reduce the effect of DC component of the data at low frequencies and noise at high frequencies. This is because most image information content is dominant at intermediate frequencies, while noise and drift are dominant at high and low frequencies, respectively. In other embodiments, the feature-extractor filter may be a band-pass filter in the spatial domain or the frequency domain that is applied on the image. The frequency specifications of the feature extractor filter can be defined based on the characteristics of the N-D image to emphasise the useful features of the image and remove noise and unimportant features of the image (such as the DC component). A suitable filter is a filter that is able to extract (emphasise) enough useful content (features) of an image while removing or ameliorating undesired features (such as noise and the DC component). This filter can be initially defined in the spatial domain of the frequency domain, but is typically applied to the image in the frequency domain.

In the spatial domain, a variety of feature extractor filters may be used including: Finite difference (first order or higher orders); Window functions (Hann, Hamming, Blackman-Harris, confined Gaussian, Blackman-Nuttal, Dolph-Chebyshev); and Savitzky-Golay smoothing differentiators (first order or higher orders) or a combination of these filters.

In the frequency domain feature-extractor filters include: the theoretical first derivative (i×ω), the product or combination of a theoretical first derivative and a frequency representation of a window function ((i×ω)×(frequency representation of a window function)); and/or a custom-designed frequency domain function (w-function) that can emphasise image information and reduce noise, such as a smoothing differentiator.

For example the smoothing filter and/or Savitsky-Golay differentiator filter discussed above are feature extractor filters. The differentiator filter emphasises high-frequency information of an image and extracts the intensity gradient of the image and the smoothing filter removes noise, leading to a more accurate registration. However, other band-pass filters can be applied on images with similar properties, which are not necessarily defined as differentiator filters.

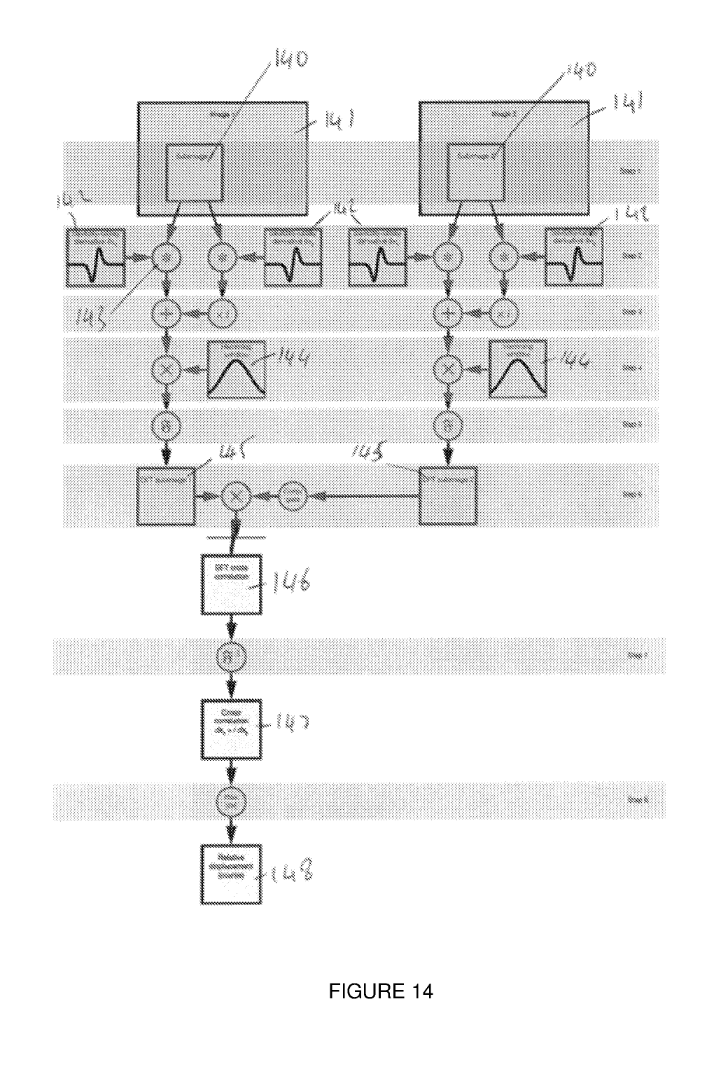

Returning to the images 140 of FIG. 15 subimages 141 are chosen in a similar way as that described with reference to FIG. 14. In contrast to FIG. 14 a window function 144, such as a Hamming window is then applied directly to the subimages 141 (e.g. without a smoothing function). A frequency domain transformation, such as a DFT 145, is then applied to produce frequency domain subimages which can be combined to form a cross-correlation between the subimages 146. For a multidimensional image N real FFTs can be applied, one in each of the N dimensions. The frequency domain cross-correlation can then be combined, or operated with, the frequency domain smoothing differentiator function representation 151 to produce frequency domain differential cross-correlation subimages. That is a measure of the gradient of the images in a particular direction. As described above this may be based on the intensity of the image, or other characteristics. As discussed in respect of FIG. 14 the inverse transform allows calculation of the image domain cross correlation 147 from which a relative displacement can be calculated.

Now reviewing the complete process shown in FIG. 15, FIG. 16, and FIG. 17 it is clear that the smoothing function, N-D filter, or smoothing differential kernel may be precalculated, or recalled from a library, as they does not directly depend on the image data. Although not required, smoothing and differentiation can also be divided into separate operations. Broadly speaking smoothing is moved to the frequency domain by applying a frequency transform to a smoothing function or kernel. Because of this change, there is little computational advantage in minimising the size of the support of the smoothing kernel, allowing more freedom in the choice of smoothing function, N-D filter, or smoothing differential kernel profiles, and the possibility of using filters with large supports, which have less ripples (i.e. less noise will be added), and can be adapted for various frequency responses. In this particular example a squared frequency domain differential kernels is then used after the Fourier transform of the image has been calculated. Decoupling the calculation of the smoothing function or kernels from the subimage convolution pipeline can provide significant savings in computational cost, leading to a simpler and faster algorithm that eliminates the need for any computationally expensive convolution operations. Furthermore, it provides a way to achieve to significantly higher registration accuracy compared to other competing methods by extracting the useful image information from the images.

In the embodiment of FIG. 15, FIG. 16, and FIG. 17 the smoothing functions and filters are represented in both the image and frequency domains. This allows much greater freedom to tailor the characteristics of the smoothing and differentiation operations with little or no impact on computational complexity. For example in the use of squared frequency domain smoothing differentials. The effect of applying differentiation both images, equivalent to squaring the frequency domain smoothing differential kernel, is to emphasise high spatial frequency image features relative to low spatial frequency features by a factor of (wₖ)². We note that method enables arbitrary weightings to be applied. Variations as discussed with respect to the method of FIG. 14, or in the above description may also be made to the method of FIG. 15 where applicable. For instance, instead of intensity a different image characteristic may be used. We also note that although the term image has been used this should be interpreted as referring to both 2D images and higher and lower order images or inputs.

In the embodiment of FIG. 16 the smoothing differentiator function (151) is represented in a more general format of N-D filters (171). The filters can be designed in the spatial domain or the frequency domain and can be combined to form a single w-domain N-D filter. The w-domain N-D filter can be chosen based on the properties of the images and can be any numbers from 1 to N.

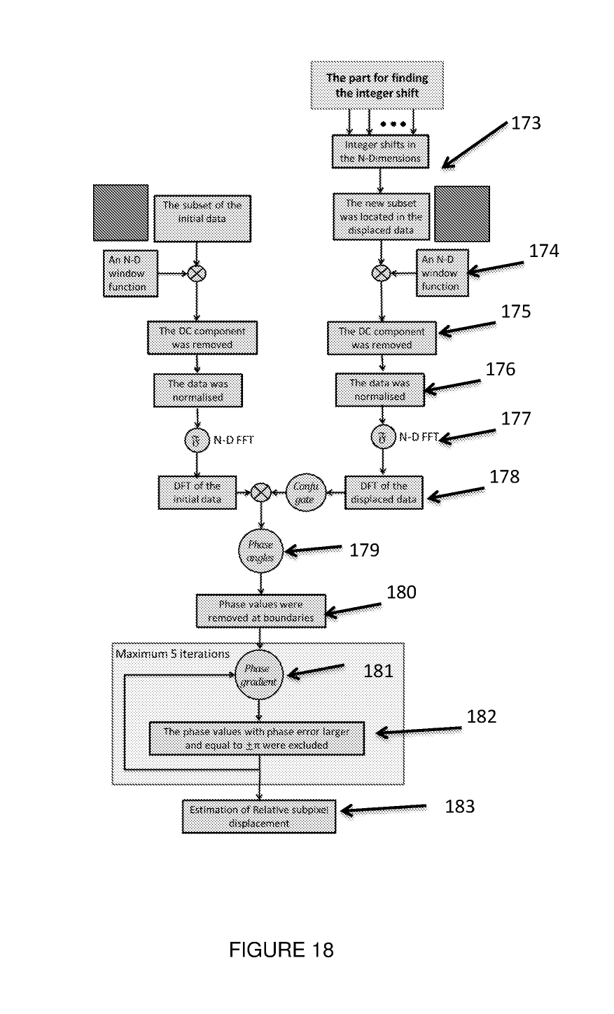

FIG. 18 shows an embodiment of the broad form of the invention in the subpixel part in which the workflow of the method is adapted to allow, at least, extending the subpixel part to images with any number of dimensions (2D, 3D, etc.). The two images are first registered within less than one pixel (173); an N-D window function is applied on the images (174). DC components were removed (175) and the data were normalised (176). N-D FFT is applied on both images (178). The FFT of one of the images was conjugated and phase angles were calculated (179). Phase values were removed from the boundaries to cancel the effects of aliasing and/or noise. In the next step the phase gradient/s were calculated using least-squares method (181). To remove the noisy, spurious signals the values with phase error larger and equal to ±π were excluded from the phase data and the phase gradient were calculated again. This process was continued until when all error values were within ±π or the iteration number reach to a number of iterations (181). The relative subpixel displacement was calculated from the phase gradient data (183).

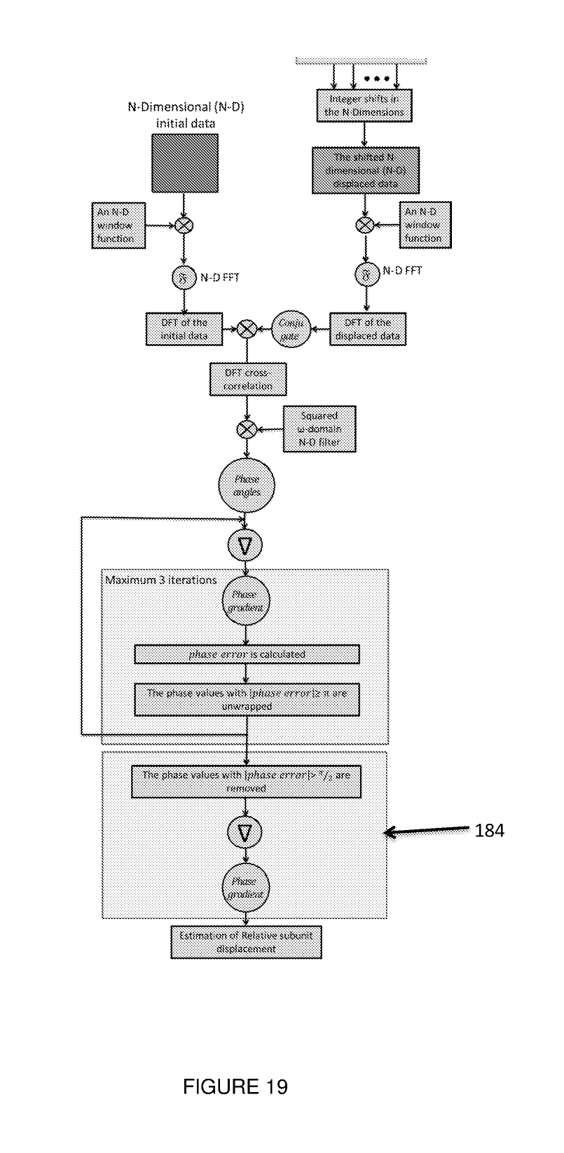

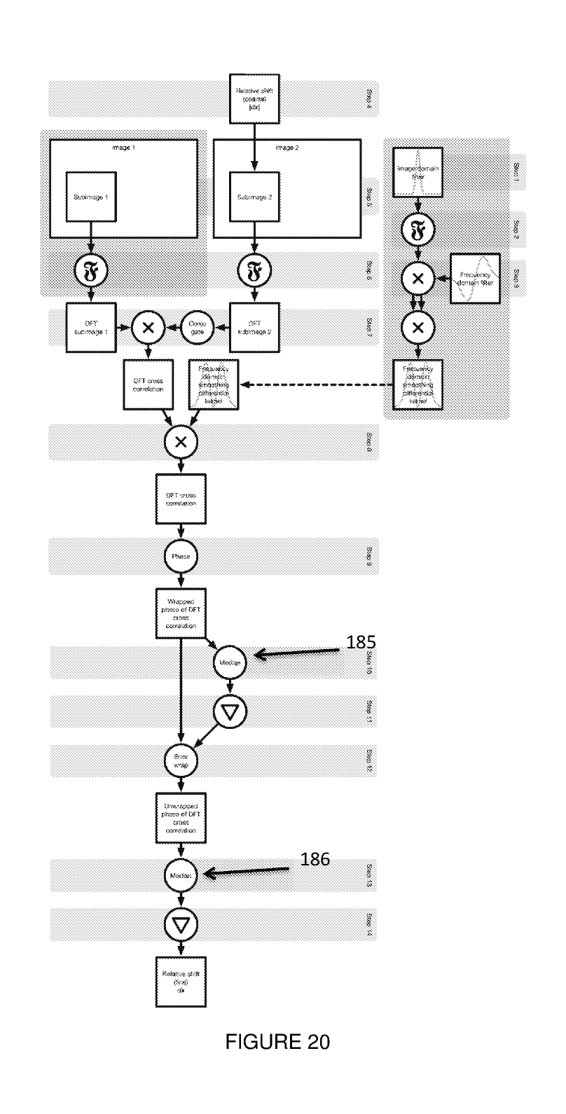

FIG. 19 and FIG. 20 are second and third alternative embodiments of the broad form of the invention in the subpixel part. The noisy, spurious signals were removed in an approach similar to 169 in FIG. 18. An extra step of removing outliers from the phase data was used in 184 in FIG. 19 where only the phase values with phase errors smaller than π/2 were selected to estimate the phase gradient. This step will help to remove the outliers with phase error larger than π/2. The outliers were removed in a further step by using a median filter was used in 185 and 186 in FIG. 20. The median filter helps to remove burst noises from the phase data, which helps to have a more accurate estimation of the gradient.

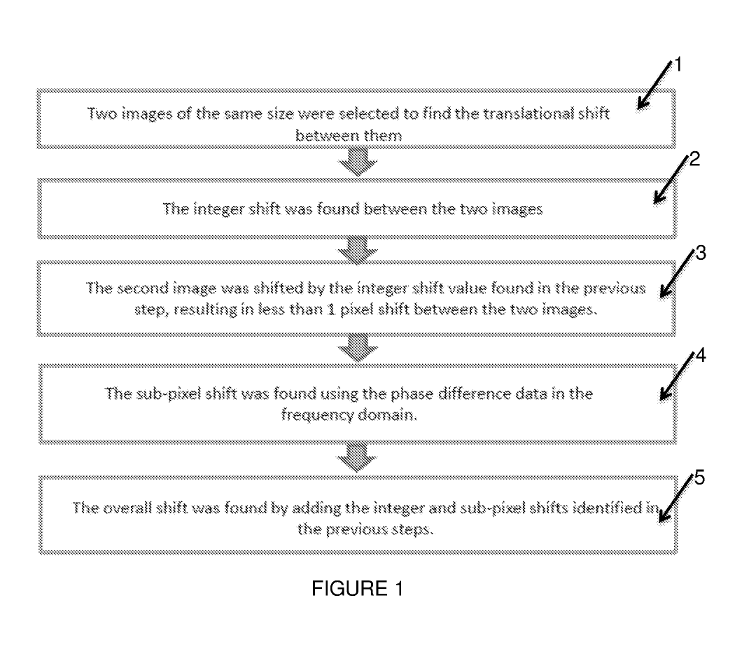

FIG. 1 shows an embodiment of the 2D version of the invention which finds a translational shift between two images. The translational shift may be in any coordinate system between images. The flow chart demonstrates a two-step process for finding translational shifts with subpixel accuracy. The method comprises a two-step method with low computational complexity. The method is able to measure subpixel shifts even in low-feature or noisy images where many existing methods have the problems described above. Having obtained two images of the same size 1 (a further step may include cropping or shrinking the images to be of matching size) the integer and subpixel shifts are found separately. The integer shift is calculated first 2. A robust method is used to ensure that all, or at least most, of the integer shifts are calculated to within one pixel accuracy, and preferably within half pixel accuracy. One of the images is then shifted so as to reduce the shift to the subpixel shift 3. A second method, preferably different from the first method, is used to determine the subpixel shift 4. If the integer pixel shift is calculated so that the pixel shift is less than 0.5 pixels the phase will be unwrapped, presenting a generally continuous curve (a 2D curve in 2 dimensions). This curve is preferably modelled as a plane. The method 4 preferably uses phase difference data in the frequency domain. The overall shift can be found by combining (e.g. adding) the integer and subpixel shifts 5.

Embodiments of the invention have been shown to be effective for both small and large synthetic shifts and synthetic image rotation. The accuracy of the method in finding shifts can be of the order of a few ten-thousandths of a pixel. In rotation tests, the method outperforms comparable techniques for finding the displacement in rotated images. The method can also provide improved robustness when images have been degraded by Gaussian noise, or other common noise in image systems. In embodiments of the invention the parameters of the system can be varied to trade-off between levels of high accuracy, low-complexity, and robustness to noise. This allows use for fine subpixel image registration or deformation measurement in applications where both accuracy and speed are important. This method can also be incorporated into coarse-to-fine image registration techniques for non-rigid transformations. The method has particular relevance in applications involving images with few features, or where accuracy and near-real-time analysis are important, robust subpixel registration methods capable of finding small to large translational shifts are required.

Rigid transformations consist of rotation and translation. Non-rigid transformations include translation and rotation combined with stretching in different image parts. The described method is particularly developed for rigid image registration (especially for finding translation). However, the method can also be incorporated into non-rigid coarse-to-fine image registration. Thus two images could first be registered by a non-rigid registration method, and then our algorithm can be used to perform the subpixel registration part (to increase the accuracy).

A further advantage of the method is that the GC removes dependence on average image intensity (zero frequency component is zero), making it relatively immune to changes in image intensity. It is possible to find the subpixel shift by fitting a function to the neighbourhood of the peak in the 2D output of the CC or GC. These methods rely on having a very good match between the two images, so that a function can be accurately fitted. The presence of noise will reduce the accuracy of this fitting. In practice, due to the intensity value changes, a good match rarely happens.

In an embodiment of the invention the integer calculation step 2 is chosen to be robust across a broad range of images. That is, the integer step 2 may have a lower accuracy to detail but is able to calculate an accurate integer shift across a broad range of images. Images may, for instance, vary by having high or low feature density or feature shape or noise levels. The accurate integer calculation use by the method allows two images to be registered to within half a pixel at the first step. Because the images have been registered to within one pixel (or half a pixel, or further) the subpixel step 4 can make certain assumptions about the information. In particular if phase data is used in the subpixel step 4, the phase data will not need to be unwrapped and can be directly processed. Existing methods have not used robust integer shift methods, for instance because of computation requirements (e.g. using cross correlation or normalised cross correlation) which struggle, especially in images with few features. The method may also slow down where the integer step, or a single step, attempts to obtain a very accurate registration. This has the effect of reducing the overall accuracy of the subpixel estimation. Embodiments of the invention comprise an integer part that is robust in finding the integer shifts, even in images with few features. This advantage of our method is critical for many practical applications, where often the image features are not rich.

The robustness may be defined as the ability to calculate the integer shift with an error of less than a set value, preferably a pixel value, more preferably 1 pixel, or 0.5 pixel, or a smaller pixel value, in noisy images or images with low features. Finding the integer shift in the proposed methods is based on matching two image features. Previous methods (e.g. cross correlation) match the intensity values, which have limited variances in low texture images, hence it is difficult to find a good match. The described method uses a gradient base method, such as SGD, to first extract the gradient of the intensity values, then it matches the gradient values using CC. The gradient method preferably has a smoothing and/or shape preserving feature. The shape preserving feature preferably minimally changes the underlying true values of the gradient. Therefore the described method can extract more features from low texture images which make the matching process more accurate.

In further embodiments of the invention the method may incorporate pixel shift calculations (preferably a subpixel shift calculation using a phase-based method) with any one or more of:
different windowing functions;
normalisation and pre-filtering of the phase difference data; and
modifications to decrease the effect of aliasing and increase the accuracy of the shift estimates.

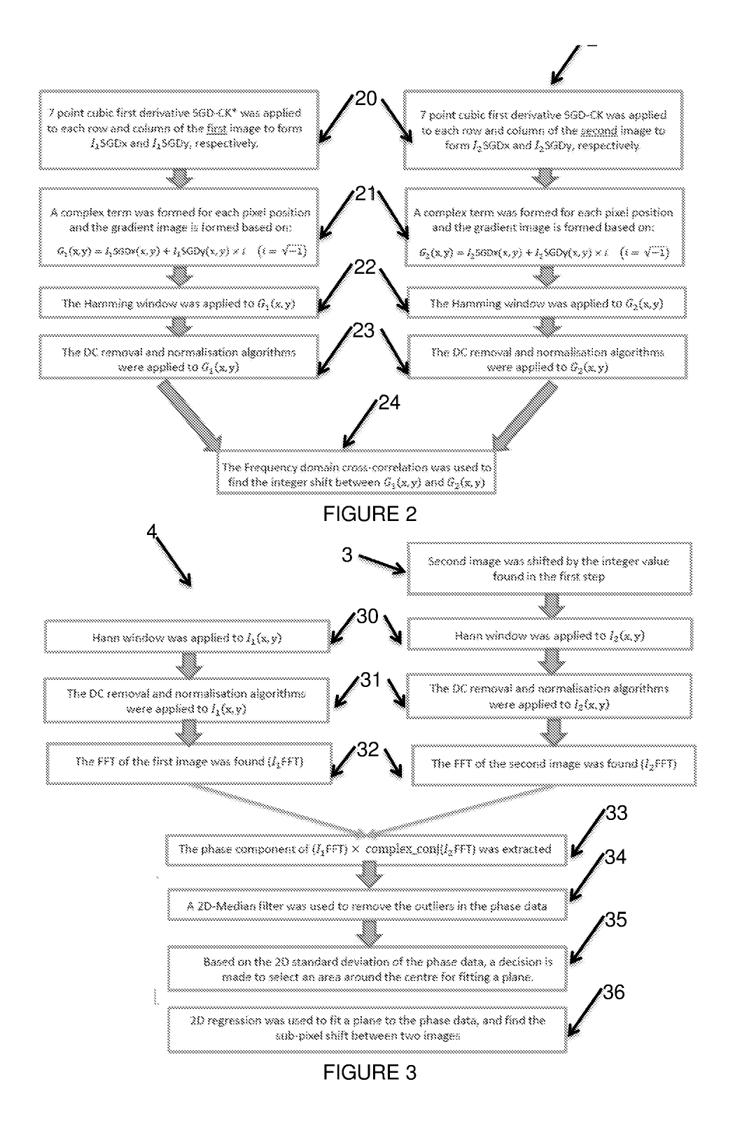

FIG. 2 shows an embodiment of the integer shift step 2. In the particular embodiment Savitzky-Golay differentiators are used to obtain a gradient correlation and find the integer shift. Embodiments of the invention use the intensity gradient input to a 2D-CC (2D-cross correlation) to find the translational shift between two images. Although the method is described with respect to intensity gradient here, other image characteristics may be used in practise, or the characteristics may be modified before the image registration occurs. Generally the characteristic values are obtained from each of the pixels of the images, but in certain cases a different or specific plurality of points is chosen. Letting I1(x, y) and I2(x, y) denote the intensity values of two grey-scale images with size of N×N at point (x, y) then the 2D-CC of two templates is defined as:

$$CC ( k , j ) = {\sum }_{x = 1}^{N} {\sum }_{y = 1}^{N} {I}_{1} ( x , y ) \times \overline{{I}_{2}} ( x + k , y + j )$$

where −N<k, j<N, and the over-bar denotes complex conjugation. The negative indexes are usually replaced with zero (i.e. zero padding). In some embodiments it is easier to compute the 2D-CC in the frequency domain using the 2D FFT and its inverse (2D IFFT):

CC=IFFT(FFT(I₁)×FFT(I̅₂̅))

I1 and I2 are intensity matrices of the images, and the 2D FFT of an image with size of N×N is given by:

$$FFT ( {I}_{1} ( k , j ) ) = {\sum }_{x = 1}^{N} {\sum }_{y = 1}^{N} {I}_{1} ( x , y ) {e}^{- 2 π t ( \frac{kx}{N} + \frac{ky}{N} )}$$

where (i=√−1). In some embodiments the normalised cross-power spectrum is used to find the translational shift:

$$NCPS = \frac{FFT ( {I}_{1} ) \times FFT ( \overline{{I}_{2}} )}{\vert FFT ( {I}_{1} ) \times FFT ( \overline{{I}_{2}} ) \vert}$$

This embodiment can be adapted to gradient correlation (GC) by replacing image intensities with intensity gradients (generally written in the form of a complex term) to find the translational shift. In a preferred embodiment the real part relates to an intensity gradient in a first direction and the complex part to an intensity gradient in a second, orthogonal, direction. To calculate the real and the imaginary parts of this complex term, horizontal and vertical intensity gradients, respectively, are approximated. Alternative techniques use central differences in the x(CDx) and y(CDy) directions to calculate the gradient:

CDx=I(x+1,y)−I(x−1,y)

CDy=I(x,y+1)−I(x,y−1)

Central differences approximate an ideal differentiation at a specific pixel position. First order central differences and second order central differences have been used. In a preferred embodiment the method uses Savitzky-Golay smoothing differentiators (SGDs) which generally provide a more accurate approximation for the ideal differentiator by smoothing the signal using running least-squares fitting to a polynomial. This is more robust and accurate than central differences, especially for noisy signals, because SGDs are not so easily affected by corruption of neighbouring points by noise. That is to say the interpolation is not directly dependent on the neighbouring points and has a smoothing effect. Because the interpolation is not as directly dependent on the neighbouring points, the accuracy can be increased by increasing the accuracy of the SGD.

A further improvement due to the use of SGDs is the preserving of the signal shape. Preserving or maintain a signal shape can comprise removing noise from signals and gathering information from neighbourhood points. That is to say the overall shape of the signal is important, as well as noise reduction. This may be achieved by using a plurality of points on either side of a signal point to create an estimate. A further useful feature of SGD is that, with the choice of appropriate filter length, they are capable of maintaining the resolution of signal derivative. Ideal digital differentiators have a disadvantage that they amplify high frequency noise. SGD is close to the frequency response of ideal differentiator at low frequencies, preserving the signal shape, but attenuates the effects of noise at higher frequencies. Therefore, in one embodiment SGD can be considered as a low-pass differentiator which can preserve the signal shape and attempts to preserve, or minimally change, the actual signal data while removing noise. This can include removing high frequency data, as noise will often appear as rapid changes in a signal. Therefore a shape preserving function, or effect, will smooth the signal. There is a trade off in the amount of noise removed because this will cause data to be lost. Functions like SGDs include differentiators which extract the image intensity gradient and are also capable of removing noise while they preserve the true image data.

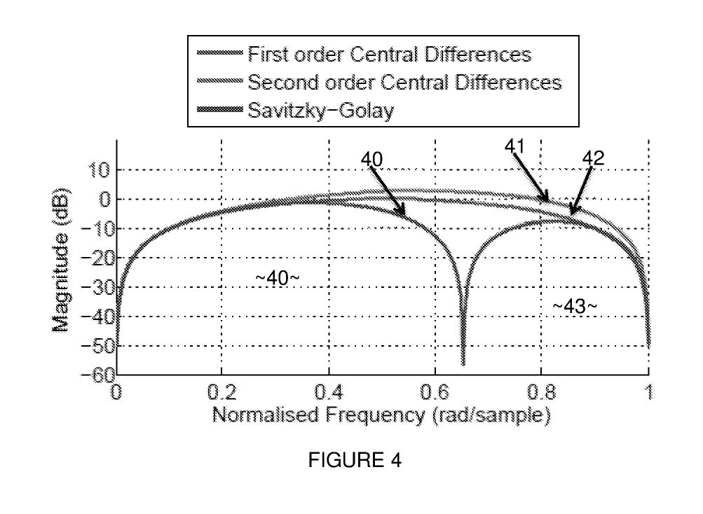

Although a particular embodiment has been described using SGDs to extract gradient information, the approach can be implemented using a broader variety of methods. One advantage of the SGD gradient estimation method, which may be achieved by an alternative method, is having a different frequency response at higher and lower frequencies which results in different characteristics in comparison to a central difference based method. FIG. 4 shows the frequency response 40, 41, 42 of central differences and SGD and there is a zero, or high attenuation at a normalised frequency of approximately 0.7, with frequency bands on either side. This frequency response can reduce the noise, preserve the signal shape, and approach the ideal differentiator at low frequencies. That is to say, it can increase the signal to noise ratio, which is useful data for the integer pixel registration. The frequency response is preferably similar to band-pass or notch filters to: keep the signal shape or true underlying values, especially at low frequencies, and remove noise from the signal, especially in high frequencies. Possible alternatives to the particular system described include using Lanczos differentiators or different orders of SGD.

In an embodiment of the invention the gradient estimation has an advantage that for discrete signals they can be easily implemented using convolution method, preferably with a table of coefficients for each filter order, instead of using running least-squares fitting. This lowers the computational cost of the method by reducing the complexity of the calculation and makes the hardware implementation (e.g. in a processor, FPGA, or GPU) feasible. Convolution methods are available for several gradient estimation methods, and for a plurality of orders of estimators. In a particular embodiment a 7 point cubic first derivative SGD is used. This is based on the frequency response properties, and uses more information from the neighbouring points. The convolution kernel of this filter is:

SGD(Kernel)=([22,−67,−58.0,58,67,−22])/252

FIG. 4 shows this kernel 40 and compares the frequency response of this kernel with first order 41 and second order 42 central differences. While the frequency response of the first order and second order central differences are similar over the whole frequency band, SGD has a different response for frequencies higher than half of the normalised frequency 43. In a particular embodiment the following implementation process is followed, however a person skilled in the art will understand that variations are possible in the combination of terms or steps described herein. The convolution kernel of the SGD is applied to each row and column of an image 20 to form SGDx and SGDy, respectively. These are combined to form the complex term of our method:

SGD=SGDx(x,y)+SGDy(x,y)×1

This term is used to form the 2D-Savitzky-Golay gradient-correlation (SGGC) 21:

SGGC=IFFT(FFT(SGD₁)×FFT(S̅G̅D̅₂̅))

where SGD1 and SGD2 are in the form of rectangular matrices.

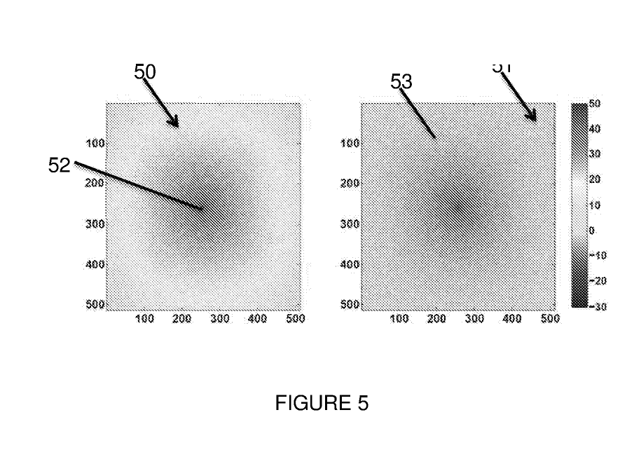

FIG. 5a shows an original power spectrum 50 and FIG. 5b shows the same spectrum 50 with noise present. FIG. 5 demonstrates that typically, due to the limited resolution of imaging systems, rapid intensity changes are uncommon in most images. The zero frequency 52 (i.e. DC component) is shifted to the centre of the image and higher frequencies are closer to the peripheral parts 53 or outside of the image. The fine details of the image are usually in the lower range of high-frequency components in comparison to the frequency of the noise components. The white Gaussian noise has spread in higher frequencies in FIG. 5(b), in comparison to fine details of the image in FIG. 5(a). This can be seen in the loss of definition around the periphery of FIG. 5b.

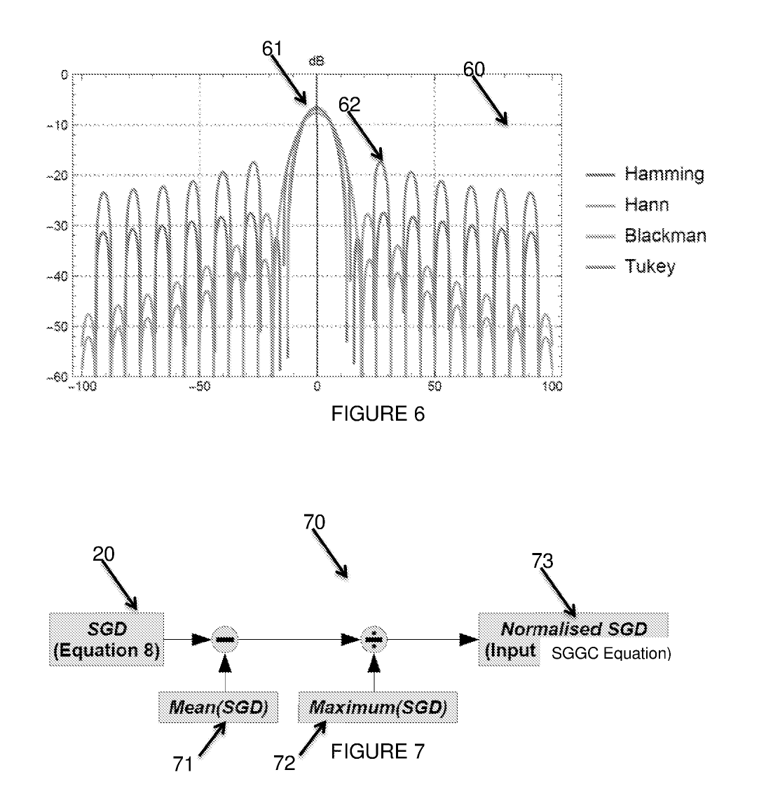

FIG. 6 shows a plurality of window functions. In embodiments of the invention a window function is applied to the gradient image 22. Further embodiments of the invention use frequency domain techniques and several window functions and parameters and/or adjustments are considered. The parameters of the window functions 60 are preferably chosen to be appropriate for the integer 2 and subpixel 4 parts or steps respectively. A window function 60 can decrease boundary effects, aliasing, and noise. This is because a window function prevents introducing spurious high frequency components caused by a rectangular window. Noise and fine details of the images (such as edges) are both at high-frequency bands in the frequency domain. Therefore selection of an appropriate window function is important to simultaneously preserve fine details (to allow an accurate matching between two images) and reduce the noise.

Usually, window functions have a trade-off between keeping image information and removing noise, aliasing, and boundary effects. Therefore, window functions (such as Blackman or Tukey) have previously been used in some methods to remove the noise. However these window functions also remove fine image features, which will result in a less accurate shift estimation. Where an algorithm is robust to noise (e.g. due to use of a shape preserving gradient estimate), a lower attenuation window can be used, such as the Hamming window. An advantage of this is that the image features are maintained in more detail. That is to say, the use of a robust integer gradient estimator can be combined with an improved window function to improve the signal to noise ratio.

Different window functions have different characteristics. Some known window functions help to remove the noise from images, but also remove the high frequency components (fine details of the image). Existing methods have used two window functions to deal with the noise. However, this choice of window functions will decrease the accuracy, since it removes the fine details of image. Instead a window function is chosen that preserves high frequency components and other techniques are used to deal with the noise. Possible techniques suggested for integer or subpixel registration include improving the normalisation algorithms, use of a median filter and use of a function to choose the phase data before the 2D regression. In some cases substantially the same, or similar techniques can be used for both subpixel and integer shifts.

In a particular embodiment a Hamming window is used because the frequency response has a mild slope of attenuation 60 (−6 dB/octave), and high attenuation (−43 dB) in the second lobe 62. This means that, for the integer shift, a large portion of the low frequency data is preserved well (due to the mild roll-off) while any noise (which is concentrated in the high frequencies) is well attenuated. The window function is then chosen with respect to the noise robustness property of the gradient estimation method. For instance Savitsky-Golay gradient correlation (SGGC) helps to extract fine details of the images, even in the presence of noise. This is because the SGD kernel or method removes, reduces, or ameliorates the signal noise from the signal before the correlation is calculated. Improved noise removal technique also enables more signal (true image) data to be kept. This combination of the gradient estimation method and window function provides a compromise between reducing the noise and maintaining fine details of the images at the higher frequencies. In comparison the Blackman window heavily attenuates after the second lobe, removing most of the high frequency information (i.e. fine details) in the images and the Tukey window doesn't have enough attenuation in its second lobe, resulting in too much noise remaining. The Tukey window will also give rise to phase distortions for the ripples in its frequency response.

FIG. 7 is a flowchart showing an improved normalisation method 23. The normalisation procedure is targeted to improve the dynamic range and robustness to noise of the method. The individual terms of the normalised cross-power spectrum (NCPS) and NGC described above included a DC component. The inclusion of the DC component results in a reduction of the dynamic range of the signal because this impacted the magnitude of the signal and relative weight of each of the frequencies. The DC component reflects an average pixel value. The flowchart 70 of FIG. 7 shows an embodiment where SGD1 and SGD2 are normalised separately (by subtracting an average (e.g. mean) value 71 dividing by a maximum absolute value 72 (or estimated maximum). The maximum is typically calculated after the removal of the mean. The normalised values 73 are then applied to the SGGC equation. This has the advantage of increasing dynamic range and decreasing intensity sensitivity. This is because the real and imaginary parts of the complex term are normalised separately after the DC removal by subtracting the mean value and are not affected by each other, or the image average values. In an alternative embodiment the DC component may be calculated in the frequency domain, for instance by obtaining the amplitude of the frequency component at zero.

FIG. 3 shows an embodiment of the subpixel integer shift step 4. In the particular embodiment a modified phase-based method is used to find the subpixel shift. Referring to FIG. 1 the subpixel registration 4 is preferably performed after images are registered within less than 1 pixel, and preferably within less than 0.5 pixel, although it may be used separately in some circumstances (e.g. where the integer shift is known, or known not to be present. The subpixel shift is preferably calculated based on a frequency shift approach. That is to say, the calculation uses a feature that the subpixel shift can be calculated by identifying the gradient of a phase characteristic, such as phase difference, in the frequency domain. As previously the system is typically evaluated with intensity values but a range of image characteristics is available if required. The plurality of points used is preferably the same as that used for the integer shift but a different plurality of points may be used.

The Fourier transform of a signal F(w) includes separate real and imaginary parts and can be represented in the form of:

F(ω)= [symbol] (F(ω))+i× [symbol] (F(ω))
The phase difference (φ) for two signals is given by:

$$ϕ = {tan}^{- 1} ( \frac{ ( {F}_{1} ( ω ) ) \times ( \overline{{F}_{2} ( ω )} )}{ ( {F}_{1} ( ω ) ) \times ( \overline{{F}_{2} ( ω )} )} )$$

In embodiments of the invention the slope of the phase difference (φ) data of the two dimensional data signals is used to find the subpixel shift. This is relatively straightforward when phase wrapping has not happened, for example where any integer shift has been calculated and removed. The step of calculating the slope of the phase difference is extendable to 2D and the phase plane (φp) to find the subpixel translational shifts in images.

In embodiments of the invention the normalisation procedure 70 described before for the integer part of the method can be applied to subpixel images 31. In preferably embodiments a window function is used 30. A preferred window function is the Hann window function, shown in FIG. 6. This is applied to the images 30 before computing the Fourier transform 32 (preferably with a FFT) of the intensity values used to calculate the phase difference 33. The Hann window was chosen because of its properties in the frequency domain. The Hann window frequency response has moderate attenuation of 31.5 dB in the second lobe and sharp slope of attenuation (−18 dB/octave). This attenuation is smaller in the second lobe but has a sharper attenuation slope compared to, for instance, the Hamming window. In the subpixel step, the images are already registered within half a pixel (larger differences are registered in the integer part and removed by shifting 3). Therefore the subpixel step is focussed on the removal of noise instead of large features. This suggests that Blackman and Hann window functions should be used to remove noise, as they are both capable of filtering noise in high frequency data. However, the Hann window also preserves relatively low frequency data because it has less attenuation in its second lobe, in comparison to the Blackman window. That is to say, the relative attenuation of the first and second lobes is higher in the Blackman window.

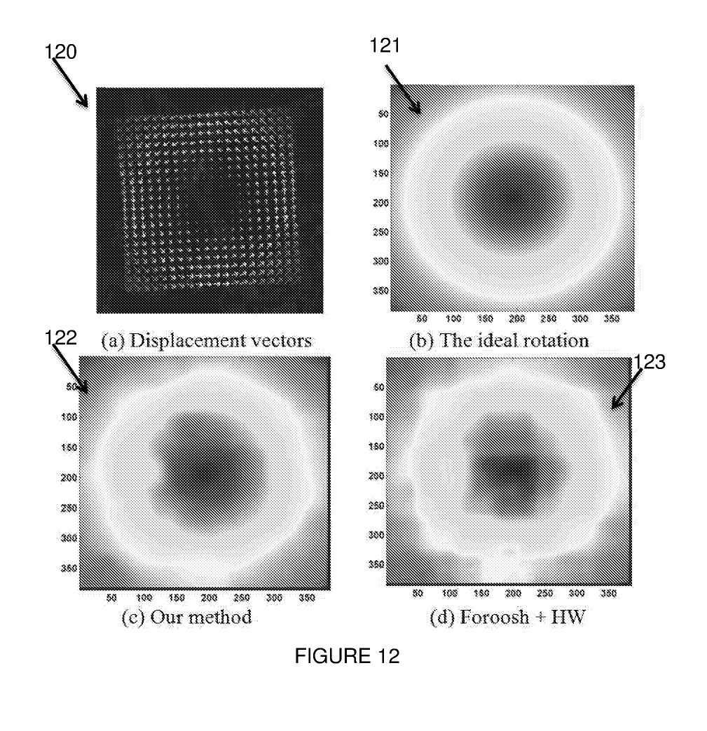

FIG. 11 shows the possible effects 110, FIG. 11(b) of aliasing and/or noise on the signal 111, FIG. 11(a), where spurious frequencies are introduced to the data. To improve the estimation of the subpixel shift from the phase data these spurious frequencies, generally caused by noise or aliasing, can be removed. Embodiments of the method comprise a 2D median filter to the data to remove the spurious frequencies. It should be understood that the parameters of the median filter or filtering method used may vary. Other digital filtering methods (e.g. smoothing filters, averaging filters and Gaussian filters) and the filter radius may be varied to find a suitable implementation. In a particular embodiment the neighbourhood size of 2D median filter was selected to be relatively small (i.e. 3×3). This helps to smooth the data without altering the slope at the centre (e.g. reducing the effect on the measured slope). This 2D median filter has the effect of improving the data used for the 2D regression (or other method) used to find the slope or gradient and calculate the subpixel shift. The 2D regression becomes less accurate when the data is affected by noise.

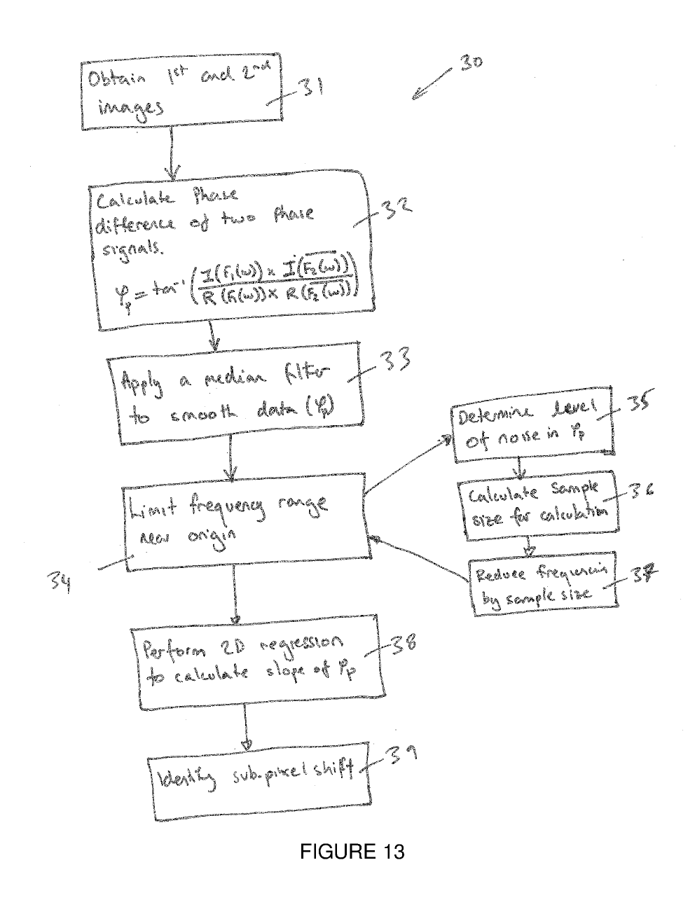

FIG. 13 is a flow chart of a method to reduce the impact of noise on the median filter. This reduces the variability, or smooths, the phase data by choosing the median of the data in a neighbourhood and applying an estimated plane to the data. A related effect may be achieved by an alternative smoothing means. In other embodiments the median filter may be replaced by a nonlinear filter which targets the noise which is most noticeable in higher frequencies. A plurality of, say first and second, images may first be selected 31; the phase data 32 can be calculated to interpret the shift. The median filter 33 may then be used to smooth the phase data. In the next step a frequency limit, or a reduction of range, is applied to the signal 34. By determining the amount of noise 35, and then calculating or obtaining an appropriate sample size 36 (e.g. based on the amount of noise) a clearer phase difference can be used by removing unwanted frequencies 37. Typically, this is implemented as a band pass or high pass type filter as noise frequencies are generally spurious high frequencies. A 2D regression or other gradient calculation technique can be used to calculate a slope of the phase difference 38 and from this identify the subpixel shift.

Previous methods have limited the frequency range of the data near the origin 34 by selecting a fixed value (e.g. ratio) for the sampled data. For instance, choosing a fixed value of 0.6 of the image size around the centre of the data as the number of samples (Nφ) to be used in 2D regression, where the value is chosen by trial and error. In embodiments of the invention the appropriate number of samples (Nφ) is dependent on a characteristic of the noise level 35 of the image. Because both the fine details of images and noise are present in the high frequency components of the frequency domain data it is important to accurately choose the number of samples (Nφ). That is to say that by selecting a smaller Nφ around the data centre, noise and fine details are filtered from the data at the same time, causing a reduction in fine details and less accuracy.

A particular embodiment of the improved method a different number of samples Nφ around the centre of data is selected 37. For instance where an image has low levels of noise a large number of samples can be used to best preserve the fine details of the image. Alternatively if a high level of noise is present the number of samples or sample size Nφ can be reduced to balance this. The noise level of an image, or a characteristic of the noise present in an image, can be calculated or determined 35 by a number of methods known to a person skilled in the art of image noise estimation. For instance the 2D standard deviation (2DSD) of the data can be used. There are more sophisticated ways of estimating the signal noise using statistical modelling. These include noise estimation techniques or blind noise estimation. The 2DSD is practical because it provides a balanced view of the noise in the data. In the ideal case of noise and aliasing free data, the 2DSD is completely symmetric, providing a 2DSD value of 0.

The noise calculation method can be used to generate a value or characteristic representing the amount of noise present in the data. A function or relationship can then be used to define or obtain a number of samples Nφ 36 dependent on the noise level. For instance a linear relationship may be applied (between upper and lower bounds). An example form of the relationship is:

$$\begin{matrix}p = \{ \begin{matrix}( 0.95 - 2 \times 2 DSD ( {ϕ}_{p} ) ) , & 2 DSD ( {ϕ}_{p} ) \leq 0.1 \\ 0.75 , & 2 DSD ( {ϕ}_{p} ) > 0.1\end{matrix} & ( 12 ) \\ {N}_{ϕ} = p \times Image size & \end{matrix}$$

In this case the maximum value of Nφ is 0.95 of the image size (to avoid border effects), and the minimum value is 0.75 of the image size (to preserve the image details). The variable p is used to correct for changes in image size (or samples taken). The maximum and minimum values may be varied where more information is known about the noise, data set or images (e.g. feature frequency or size) or other parameter. In other embodiments the relationship may be nonlinear or complex to better calculate a number of samples. In some embodiments principal component analysis (PCA) and singular value decomposition (SVD) may be used to find the gradient of the phase plane data instead of 2D regression, although these typically require more computations.

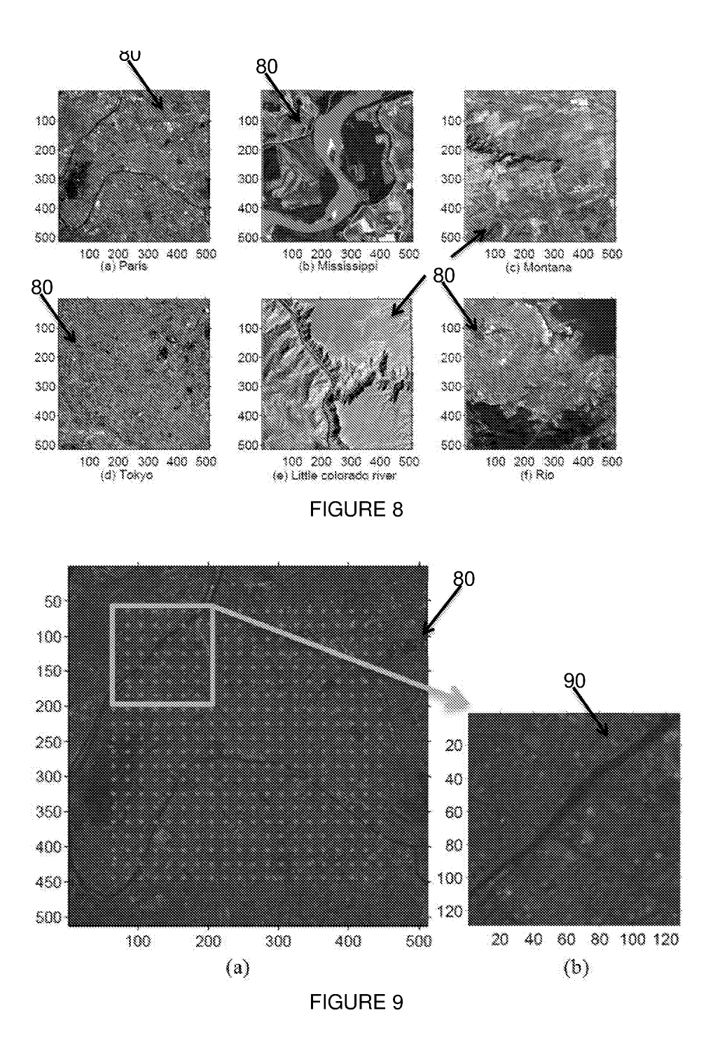

FIG. 8 shows six standard LANDSAT images 80 on which the invention may be evaluated by applying synthetic shifts and then estimated the shift value resulting from each method. A variety of subpixel or integer shifts, e.g. in two groups consisting of values smaller or greater than 1 pixel can be applied using FFT-shift (since it resembles real-world experiments). FIG. 9 shows how images 80 can be cropped to a certain size, or sub-images 90, if required. The central points of subimages 90 were selected across the entire image, with a step increment of 20 pixels, and the minimum distance of 64 pixels to the periphery. This resulted in 400 subimages for each image, and 2400 subimages in total for six LANDSAT images 80. Dividing an image into sub-images allows local, regional, a portion or all of displacements or deformations to be calculated. The deformational map of the whole images is a combination of the data from each of the sub-images. The use of sub-images can be advantageous for rotations, or other non-uniform translational changes, over large areas. The size of sub-image chosen can vary depending on the type of deformation/change, and the intrinsic features of the image.

The average registration error in finding the translational shift (RMSET) was computed based on:

$${RE}_{T} = \frac{{\sum }_{m = 1}^{6} {\sum }_{n = 1}^{400} \sqrt{{( x ( m , n ) - \hat{x} ( m , n ) )}^{2} + {( y ( m , n ) - \hat{y} ( m , n ) )}^{2}}}{2400}$$

where [x, y] is the pixel position, hat indicates the estimated pixel position values, m is the LANDSAT image 80 number and n is its subimage 90 number. The registration error or other error may be calculated in a mean square sense. RET values were used to evaluate the performance of methods in finding translational shifts. An appropriate window function is used to improve the performance of the image registration method. In particular, existing methods can be improved with the addition of a Hann window.

To evaluate the translational shift error in the presence of rotation, rotation values of 0.5°, 1°, 2° and 3°, and were applied to the whole image in six LANDSAT images with the centre of rotation at the middle of the image. The images 80 were cropped to subimages before and after applying the rotations. The translational shifts in the x and y directions were then calculated by the described method. An estimation of error can be calculated based on translations in two dimensions. This may include a comparison of the calculated magnitudes of the translational shift Tx, Ty, for each subimage 90:

M=\sqrt{(Tₓ)²+(T_{y})²}

This translational shift can be interpolated to provide a continuous rotation pattern on the whole image. The magnitude of the shift from an ideal rotation for each subimage 90 can be modelled as:

$$[ \begin{matrix}{x}_{r} \\ {y}_{r}\end{matrix} ] = [ \begin{matrix}{x}_{0} \\ {y}_{0}\end{matrix} ] + ( [ \begin{matrix}x - {x}_{0} \\ y - {y}_{0}\end{matrix} ] \times [ \begin{matrix}cos θ & - sin θ \\ sin θ & cos θ\end{matrix} ] )$$

$${M}_{r} = \sqrt{{( {x}_{r} - x )}^{2} + {( {y}_{r} - y )}^{2}}$$

where theta is the rotation angle in radians, [x0, y0] is the centre of the image, and [xr, yr] is the pixel position of the point [x, y] in the rotated image. The comparison may be an average registration error for rotation:

$${RE}_{R} = ( {\sum }_{m = 1}^{6} {\sum }_{n = 1}^{400} \sqrt{{( {M}_{r} ( m , n ) - M ( m , n ) )}^{2}} ) / 2400$$

Where m and n are reference numbers for images and subimages.

Embodiments of the invention were tested based on the synthetic shift of images. This technique applies known synthetic shifts to test images and to find the shift estimation error of the methods. The method was compared to existing methods described by other parties. White Gaussian noise is usually added to the images before the shift estimation. Two error metrics were defined to evaluate the accuracy of the integer and subpixel parts of our method. These metrics provide estimates of the method accuracy when applied to specific images and where it is not possible to perform rigid object translational tests.

The error metrics, or other methods of identifying accuracy, can be used to analyse the accuracy of integer and subpixel shift identification. Estimating the accuracy is of particular interest in applications where it is important to have a confidence metric for the measurements. These metrics estimate the method accuracy in distinct and different images with different features and noise levels. The distinctiveness of the dominant peak in the output of 2D-CC or GC is often considered to be indicative of the ability of the method in determining the integer shift. For the integer part, the number of points in which the normalised SGGC value in was greater than 0.85 was used to indicate the error in finding the integer shift in our proposed method. The closer this metric value is to 1, the less shift estimation error will be achieved by the method in the integer part.

FIG. 14 shows an embodiment similar to that described above and shown in FIG. 2. Two subimages 140 are shown being chosen from larger images 141. In alternative cases entire images may be used, however it may be beneficial to instead use a plurality of subimages chosen from within the main images. The best size of the subimages will be determined by the relative playoff between accuracy and locality, as well as the noise characteristics of the images. The information, or feature size of the image will affect both size and overlap. In order to calculate an accurate overlap the subimages should have substantial overlap of common features, as this provides sufficient information to create a match.

The subimages are then processed 143 by a smoothing function 142, such as a Savitzky-Golay derivative. The smoothing function 142 may be applied once for each dimension of the images (which may be shapes or inputs in higher dimensions). If a real filter is being used 2-dimension estimates may be combined to form a single complex estimate. In higher dimensions, multiple real FFTs can be used for each dimension or each image feature instead of a single complex FFT. The peak can be found based on the magnitude of the real FFTs. As described previously a window function 144, such as a Hamming window can then be used to limit spectral leakage. Although a Hamming window is used other variants may alternatively be used, including confined Gaussian windows, Blackman-Nuttall windows, or Dolph-Chebyshev windows. The modified subimages are then converted from the image domain into a frequency domain representation. This is preferably through a Fourier transform 146 such as a discrete Fourier transform (DFT) or fast Fourier transform (FFT). Although a frequency domain transform is described, a skilled person would be aware that other domain transforms exist, such as the discrete wavelet transform (DWT), and may provide similar results. A frequency domain cross-correlation 147 is then performed by multiplication of the modified first subimage with the complex conjugate of the modified second subimage. Once calculated an inverse transform converts the cross-correlation back into the image domain from which the relative displacement may be calculated. For instance the cross correlation can be calculated or obtained 148 by finding the largest complex absolute value of the elements of the image domain cross correlation.

The error metric of the subpixel part was defined to be the plane fitting error for the plane fitted to (pp. For instance the fitting error may be calculated by a norm, or a least squares method. A small fitting error indicates good accuracy of the method in estimation of the subpixel shifts. The pre-filtering of the phase data using a 2D-median filter with a small neighbourhood helps to remove outliers from the phase data, resulting in robust plane fitting, and thus a reliable subpixel error metric.

Table II and Table III show shifts in the x and y directions ([x, y]) for each of a selection of existing methods. The average of our method is approximately four times smaller than the next best method (i.e. Stone et al, U.S. Pat. No. 6,628,845), for shifts of less than one pixel (Table II). This demonstrates that, although we have chosen a similar procedure for subpixel displacement measurement, our modifications have significantly improved the accuracy.

TABLE II
THE AVERAGE REGISTRATION ERRORS (IN PIXEL) FOR ALL 2400 LANDSAT SUBIMAGES (128 PIXEL × 128 PIXEL) (RE_{T})
FOR THE SUBPIXEL SHIFTS INDICATED IN THE FIRST COLUMN. THE FINAL ROW PROVIDES THE RELATIVE DIFFERENCE
IN THE AVERAGE REGISTRATION ERRORS QUANTIFIED WITH RESPECT TO THAT OF OUR PROPOSED METHOD

| Shift [x, y] | Vandewalle [16] | Stone [15] | Guizer [13] | Foroosh [9] | Foroosh + HW | Our Method |
|---|---|---|---|---|---|---|
| [0.125, 0.875] | 0.035815 | 0.000528 | 0.067903 | 0.052756 | 0.001667 | 0.000104 |
| [0.250, 0.750] | 0.031030 | 0.000906 | 0.071724 | 0.075696 | 0.004026 | 0.000209 |
| [0.375, 0.625] | 0.028098 | 0.001208 | 0.072276 | 0.103270 | 0.007156 | 0.000317 |
| [0.500, 0.500] | 0.027057 | 0.001418 | 0.073388 | 0.142843 | 0.012085 | 0.000423 |
| Average | 0.030500 | 0.001015 | 0.071322 | 0.093641 | 0.006233 | 0.000263 |
| Relative difference | 115.85 | 3.85 | 270.93 | 355.71 | 23.67 | 1 |

TABLE III
THE AVERAGE REGISTRATION ERRORS (IN PIXEL) FOR ALL 2400 LANDSAT SUBIMAGES (128 PIXEL ×
128 PIXEL) (RE_{T}) FOR SHIFTS GREATER THAN 1 PIXEL. THE FINAL ROW PROVIDES THE RELATIVE
DIFFERENCE IN THE AVERAGE REGISTRATION ERRORS TO THAT OF OUR PROPOSED METHOD.

| Shift [x, y] | Vandewalle [16] | Stone [15] | Guizer [13] | Foroosh [9] | Foroosh + HW | Our Method |
|---|---|---|---|---|---|---|
| [1.125, 2.875] | 2.934300 | 0.406220 | 0.157563 | 0.021824 | 0.002727 | 0.000104 |
| [3.250, 4,750] | 5.702116 | 3.307433 | 0.225113 | 0.043807 | 0.006854 | 0.000208 |
| [5,375, 6,625] | 8.488283 | 7.028266 | 0.317888 | 0.058794 | 0.012646 | 0.000315 |
| [7,500, 8,500] | 11.295033 | 10.032950 | 0.424995 | 0.106426 | 0.038723 | 0.000421 |
| Average | 7.104930 | 5.193717 | 0.281389 | 0.057712 | 0.015237 | 0.000262 |
| Relative difference | 27118.06 | 19823.34 | 1074.00 | 220.27 | 58.15 | 1 |

Table III quantifies the ability of our method to find integer and subpixel shifts. The method of Vandewalle is not capable of finding subpixel shifts of more than one pixel, because of phase wrapping. The result using the method of Stone et al (U.S. Pat. No. 6,628,845) indicates the difficulty that CC has with finding integer shifts in poorly textured subimages. A similar issue arose (albeit to a lesser degree) when using the method of Guizar et al, which failed to find the correct integer shifts in some cases. The method of Foroosh et al was reasonably reliable because of the advantages of Phase correction (PC) over CC. However, these results highlight an issue of the increase in error for non-overlapping regions (where regions are present in one image but not another). Of the previously published methods, the method of Foroosh was shown to be improved with the addition of a suitable (in this case a Hann) window. Foroosh may have chosen not to use a window because a bad choice of window function can result in losing image information The Foroosh+HW method performed the best. The embodiment of the invention method provided an average 58 times smaller than the closest existing methods and performed consistently well for calculating small and large shifts (Table II and Table III, respectively). The comparison of the accuracy between Foroosh and Foroosh+HW in Table II and Table III emphasise the role of an appropriate window function in increasing the accuracy.

Gaussian noise is the dominant type of noise in most imaging systems due to random noise entering the data collection or processing method at various stages. To investigate the robustness of our method to noise, a Gaussian white noise (zero mean, variance to of the normalised intensity values) was added to the LANDSAT image of Paris. The registration error was calculated and averaged for estimating the [x, y] shift of [3.250, 4.750], over 400 subimages 90.

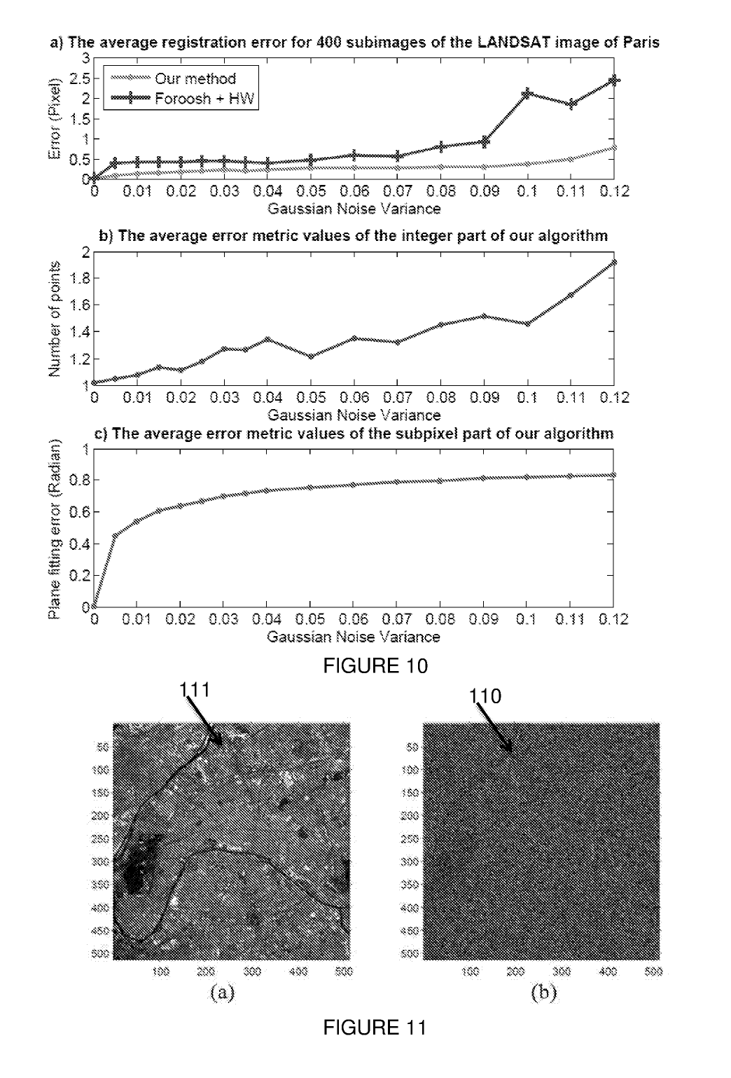

FIG. 10 shows that the method has considerably lower estimation error in comparison to an existing system for each of the applied Gaussian noise ranges. The average registration error of an embodiment of the invention was 0.78 pixels, even with a large amount of Gaussian noise (FIG. 10a, with noise having variance 0.12 of normalised intensity values.). To evaluate the capability of the integer and subpixel error metrics in showing the method accuracy, these two error metrics were calculated at each Gaussian noise level for our method (FIG. 10(b)-10(c)). The figures demonstrate the direct relation between the average registration error of the method and the integer error metric value at the same level of Gaussian noise. The mild slope of increase in the registration error in FIG. 10a resulted in a gradual increase in the integer error metric from 1 to approximately 2. In addition, FIG. 10b shows the integer part of the method performs well in finding the correct integer shift between the two subimages 90, even in presence of significant Gaussian noise, by taking advantage of the inherent noise-robustness of SGDs or similar techniques. The average number of points with normalised SGGC values greater than 0.85 was less than two points for all subimages 90, even with appreciable Gaussian noise having a variance of 0.12, (a²=0.120).

FIG. 10c shows that for the subpixel error metric the values increased rapidly at the beginning, where the method subpixel accuracy was decreased from 0.0001 pixel to 0.2 pixel. After that, the changes in subpixel error metric values became smaller since the rate of decrease in subpixel accuracy was also reduced. This trend in the subpixel error metric values showed that this metric is sensitive enough to be an indication of the method accuracy in estimation of subpixel shifts.

In existing methods for fine registration the registration method is able to estimate the rotation using the pseudo-polar FFT. However the rotation estimation is not as accurate as the translational shift estimation, and is usually used to find the rotation when the rotation centre lies at the centre of the image. In most practical applications, rotation is part of a non-rigid image transformation. This type of rotation decreases the accuracy of rigid image registration methods, and pseudo-polar FFT is unable to estimate that correctly.

FIG. 12 shows an example of displacement vectors estimated by our method, and previous methods, before and after applying rotation to the LANDSAT image 80 of Mississippi. FIG. 12b shows the ideal rotation calculated and presented mathematically. The rotation pattern estimated by our method 122 is the closest pattern to the ideal rotation 121. The average registration error in this image was 0.0834 pixels for our method. Table IV summarises the RE_{R} of existing methods and the described method for rotation values from 0.5° to 3°. Our proposed method has the smallest average RE_{R} for all rotations. Other methods fail to find the displacements for rotations larger than a certain degree. This is, in part, because rotations of more than 1° cause displacements larger than 2 pixels. Where methods do not robustly estimate large displacements they become incapable of accurately calculating or solving this rotation.

TABLE IV
THE AVERAGE REGISTRATION ERRORS (IN PIXEL) FOR ALL 2400 LANDSAT SUBIMAGES (128 PIXEL × 128
PIXEL) (RE_{R}) FOR ROTATION. THE FINAL ROW PROVIDES THE RELATIVE DIFFERENCE IN THE AVERAGE
REGISTRATION ERRORS QUANTIFIED WITH RESPECT TO THAT OF OUR PROPOSED METHOD.

| Rotation [θ degree] | Vandewalle [16] | Stone [15] | Guizer [13] | Foroosh [9] | Foroosh + HW | Our Method |
|---|---|---|---|---|---|---|
| 0.5 | 0.406665 | 0.031312 | 0.09679.8 | 0.140413 | 0.074887 | 0.057416 |
| 1 | 2.187433 | 0.484633 | 0.188805 | 0.344683 | 0.127640 | 0.062793 |
| 2 | 4.987100 | 3.005250 | 0.584228 | 0.934801 | 0.300593 | 0.145601 |
| 3 | 7.558916 | 6.083950 | 1.076191 | 1.875550 | 0.460365 | 0.279825 |
| Average | 3.785028 | 2.401286 | 0.488505 | 0.823861 | 0.240871 | 0.136408 |
| Retative difference | 27.74 | 17.60 | 3.56 | 6.04 | 1.76 | 1 |

In some cases particular rotations or variations may particularly suit a method. The only case in which a method had lower error than our proposed method was for Stone's method U.S. Pat. No. 6,628,845 in the case of rotation of 0.5°. The main reason for this arises from the difference between the SGGC and CC methods in the integer part of the method. For instance the CC used by Stone et al is weak for finding integer shifts (i.e. shift values larger than or equal to 1 pixel). In the case of average 1.28 pixel shifts, the shift was less than 1 pixel in many of the subimages. Therefore the lack of a robust integer shift does not hinder Stone's method (which uses CC, and may have recorded no shift for some of the images) for certain cases, such as small rotations. However outside of this magnitude range the accuracy is lost. In a particular embodiment the described method can estimate rotation by dividing the image to smaller subimages, even though it has not been particularly designed for this purpose.

In the presence of Gaussian noise the integer and subpixel error metrics can be evaluated for image rotation tests. For this purpose, two LANDSAT images with different levels of image features (i.e. Paris (FIG. 5 (a)) and Mississippi (FIG. 5 (b)) were selected. The LANDSAT image of Paris has more features compared to the LANDSAT image of Mississippi. The density of features (and corresponding feature size) can affect the accuracy of the method. A rotation of between 0.5° and 3° was applied to each image, and the displacement registration error of our method and the two error metrics were calculated at each rotation angle. The results are summarised in Table V and VI for the LANDSAT image of Paris and Mississippi, respectively. The results show the integer part of the method is more sensitive to rotation than to Gaussian noise. The results show broadly similar error metrics for both images, demonstrating the robustness of the system to different images with different textures.

TABLE V
THE ERROR METRICS FOR INTEGER AND SUBPIXEL PARTS
OF OUR ALGORITHM FOR THE LANDSAT IMAGE OF PARIS

| Rotation | Error metric | Error metric | Displacement error |
|---|---|---|---|
| degree | (integer part) | (subpixel part) | (pixel) |
| 0.5 | 1.7225 | 0.13766 | 0.0555 |
| 1 | 1.7250 | 0.18762 | 0.0379 |
| 2 | 1.9450 | 0.32536 | 0.0863 |
| 3 | 2.3350 | 0.51955 | 0.1934 |

TABLE VI
THE ERROR METRICS FOR INTEGER AND SUBPIXEL PARTS OF
OUR ALGORITHM FOR THE LANDSAT IMAGE OF MISSISSIPPI

| Rotation | Error metric | Error metric | Displacement error |
|---|---|---|---|
| degree | (integer part) | (subpixel part) | (pixel) |
| 0.5 | 2.0875 | 0.13777 | 0.0560 |
| 1 | 2.0350 | 0.19238 | 0.0834 |
| 2 | 2.6525 | 0.34667 | 0.2065 |
| 3 | 3.5250 | 0.54151 | 0.4031 |

Embodiments of the invention can have a considerably smaller computational cost compared to methods using iterative optimisation processes, or up sampling methods. It requires fewer computations than using singular value decomposition and an optimisation method. The computation complexity of SVD and 2D FFT are O(N\hat{ }3) and (N\hat{ }2 log N) respectively. This implies 60.74 faster calculations for 124 pixels. The relatively small computational cost of our proposed method and its parallel nature makes it suitable for hardware implementation in GPUs and FPGAs for near real-time applications.

Aspects of the invention that make the method suitable for hardware implementation include:
Low computation complexity (the method does not include any complex operation);
No optimisation processes (iterative optimisations are usually difficult to implement in hardware accelerators); and
Low memory storage requirements (our method requires low memory space.) Parallelism is one of the best ways of increasing the processing speed (i.e. decreasing the computation time) in hardware (e.g. multi-core processors, FPGAs, GPUs). Methods with parallel natures consist of completely, or at least substantially independent, and separable parts which can be run in parallel. The described method can be applied to subimages of an image at the same time and in parallel, since the registration is independent in each subimage. This parallelism will lead to a considerable speed up in parallel hardware accelerators (e.g. FPGAs, GPUs, and multi-core processors).

In addition to the translational shift tests a method for evaluating the subpixel image registration methods for measuring the displacement in the presence of rotation was described. The method outperformed existing methods in finding the rotation pattern and displacements.

Embodiments of the invention are designed for measuring subpixel translational shifts, because of its high level of accuracy and robustness it has the capability to be incorporated into coarse-to-fine image registration techniques for non-rigid transformations.

In a particular embodiment of the invention the image registration may be applied to surface deformation measurements for a variety of soft and hard materials. For instance, the surface deformation of soft tissues (e.g. skin, and breast) is difficult to calculate by direct measurement or using camera images. However using embodiments of the image registration method as described above allows accurate measurement from remote images. In an embodiment a series of photos may be taken of the any soft or hard material (e.g. soft tissue), and the image registration method is used to accurately align each of the images to find the displacements. The changes or deformations in the soft or hard material surfaces (e.g. soft tissues) can then be detected from the outstanding changes in the images. Although described herein in relation to soft tissue and the camera image, the technique may be similarly being applied to other medical applications for finding changes, deformations, or motions in other organs (e.g. cardiac tissue, brain, and liver) using variety of image modalities (e.g. MRI, CT-Scan, ultrasound, microscopic). In some embodiments the images may not be in the visible or optical spectrums. For instance MRI images and X-ray images may be registered. The method may be applied to medical images to allow for motion compensation caused by, for example, patient movement or breathing.

In further embodiments the image registration technique is applied to an industrial imaging system. For instance, the image registration technique may be applied to machinery for sorting and grading of food, such as fruit. This requires interfacing the system with high frame rate cameras. Another industrial example is the measurement of Poisson's ratio in elastic materials. Embodiments of the system may be adapted for robust processes based on changes, where low surface features are present. Embodiments of the invention may be varied to apply to requirements for high or low surface feature images. In a further example the image registration method may be applied to flow measurements, and in particular particle image velocimetry (PIV) videos (images). Flow measurements can track the movement of fluids through guides or channels of a device by viewing changes in images. Although a variety of applications are desired these do not limit the scope of the invention.

Furthermore the image registration method can be tailored to a particular embodiment by trading off accuracy, speed and complexity.

The method shown in FIG. 14 works particularly well with 2 dimensional images because the use of a complex subimage allows a reduction in the number of Fourier transforms required (as Fourier transforms are relatively expensive computationally). The method also assumes that the registration objective function or matching criteria should be formed in the same way each time the method is used. That is to say that the registration matching criteria should be formed as the cross-correlation of a sum of first derivatives of subimages or various other image features, such as the intensity cross derivatives. The selection of a suitable smoothing function was described above as a balance of reducing noise and having appropriate frequency properties to preserve true underlying values. The suitable smoothing function may also be a function of the support for that smoothing function. Support is typically directly related to the number of points that were selected for finding the, e.g. intensity gradient (or another image feature). A neighbourhood of 1 point is an example of a small support. A relatively small support reduces the computational cost of the convolution operation (which is directly proportional to the size of the support), but is a limiting factor for choosing an appropriate frequency response. However, in the described method we have addressed the issue of computational costs of filters with large support by applying that in the frequency domain. In other embodiments a more complex smoothing function may be required, or higher dimension inputs from images or image features may be used.

In the embodiment of FIG. 17 the N-D filters (171) is presented in form of a frequency domain smoothing differential kernel (172).

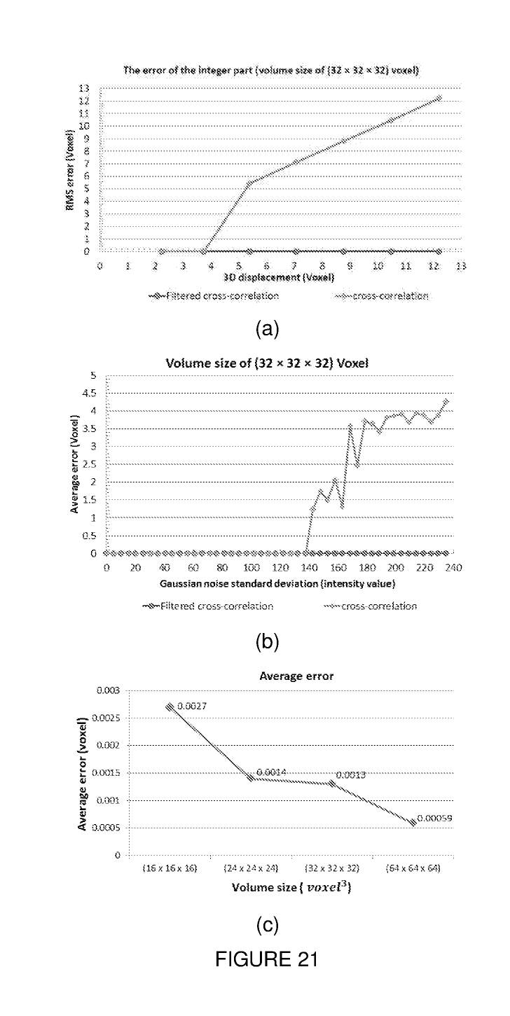

FIG. 21a shows the advantage of an embodiment of the method with filtered cross-correlation (FCC) compared with cross-correlation (CC) in 3D test images (volumes). The N-D filter used for these measurements was a 3D Savitzky-Golay filter (171) and the output of inverse FFTs (174) were weighted equally to 1. FIG. 21b shows the noise robustness of filtered cross-correlation (FCC) compared with cross-correlation (CC) in 3D test volumes. FIG. 21c shows the accuracy of an embodiment of the method described for test volumes with various sizes are shown in the below plot.

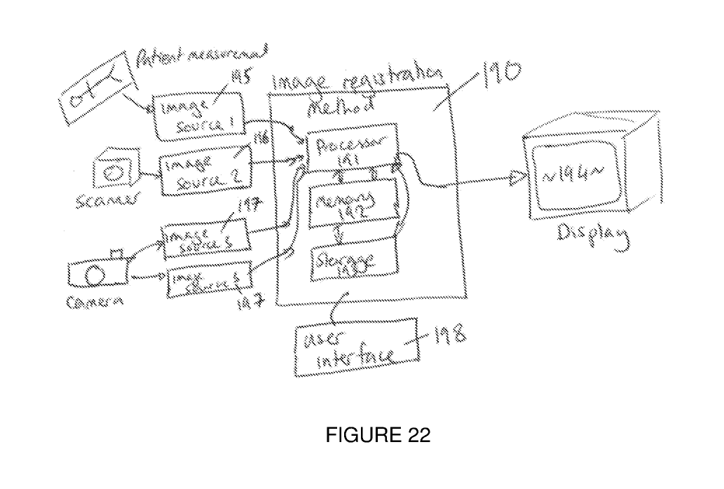

FIG. 22 shows a schematic diagram of an image registration method. The image registration method 190 is preferably contained on a processor 191, or in associated memory 192 or storage 193. The processor may receive a plurality of inputs including from image sources. Image sources include 2D and/or 3D cameras or measurement devices. These include patient measurement techniques such as x-rays 195, 3d scanners 196 or cameras 197. However the method is not limited to these techniques or image sources. In some embodiments image sources may be the same source at different timing as shown for camera 197. The image registration method may also have a user interface 198 to allow a user to adapt or control the image registration method, for instance by selecting a feature-extractor filter. The image registration method may use a memory 192 or storage 193 to store images before performing the image registration method. The registered images, a combination of these, or an output from the combination of registered images may be displayed on a monitor or display means 194.

Those skilled in the art will appreciate that the methods described, or parts thereof, are intended to be performed by general purpose digital computing devices, such as desktop or laptop personal computers, mobile devices, servers, and/or combinations thereof communicatively coupled in a wired and/or wireless network including a LAN, WAN, and/or the Internet. In particular, the system is preferably implemented using a processor in a general purpose computer, however alternative architectures are possible without departing from the scope of the invention. The processor means or processor 190 described may be a GPU, FPGA, digital signal processor (DSP), microprocessor, or other processing means. The system may also comprise a camera or other image recording device 195, 196, 197 to record images for registration. Such devices or images include MRI images, ultrasound, CT scans, microscope images and satellite images. In other embodiments the image registration method may be stored in a camera, or processor associated with a camera.

Once programmed to perform particular functions pursuant to instructions from program software that implements the method of this invention, such digital computer systems in effect become special-purpose computers particular to the method of this invention. The techniques necessary for this are well-known to those skilled in the art of computer systems

From the foregoing it will be seen that an image registration method and system is provided which offers improved accuracy for integer and subpixel shifts.

Unless the context clearly requires otherwise, throughout the description, the words “comprise”, “comprising”, and the like, are to be construed in an inclusive sense as opposed to an exclusive or exhaustive sense, that is to say, in the sense of “including, but not limited to”.

Although this invention has been described by way of example and with reference to possible embodiments thereof, it is to be understood that modifications or improvements may be made thereto without departing from the scope of the invention. The invention may also be said broadly to consist in the parts, elements and features referred to or indicated in the specification of the application, individually or collectively, in any or all combinations of two or more of said parts, elements or features. Furthermore, where reference has been made to specific components or integers of the invention having known equivalents, then such equivalents are herein incorporated as if individually set forth.

Any discussion of the existing methods or prior art throughout the specification should in no way be considered as an admission that such prior art is widely known or forms part of common general knowledge in the field.

1. A method for registration of a plurality of images, the method comprising:
obtaining a frequency domain representation of one or more spatial domain or frequency domain functions or filters or kernels, wherein each function emphasises at least one image characteristic;
combining functions into a single frequency domain representation function; and
applying the combined frequency domain representation function to the images to determine relative displacement.

2. The method for registration of a plurality of images as claimed in claim 1, wherein the plurality of images is of same and/or differing dimensions and/or sizes.

3. The method for registration of a plurality of images as claimed in claim 1, wherein the function can be a smoothing function that is defined in the spatial domain.

4. The method for registration of a plurality of images as claimed in claim 1, wherein one of the image characteristics emphasized by the function is reduced effect of noise and/or increase in an image signal to noise ratio.

5. The method for registration of a plurality of images as claimed in claim 1, wherein the function can be precalculated before applying to the images.

6. The method for registration of a plurality of images as claimed in claim 1, wherein the method further comprises applying the frequency, domain representation of the function to a frequency domain representation of cross-correlation.

7. The method for registration of a plurality of images as claimed in claim 1, wherein the method further comprises a library of precalculated frequency domain functions.

8. The method for registration of a plurality of images as claimed in claim 1, wherein the frequency domain functions are selected from the library depending on the image dataset.

9. A method for registering a plurality of images, the method comprising:
applying functions to calculate shifts between images;
applying phase unwrapping techniques to exclude phase data outliers; and
employing phase data to calculate subpixel shifts between the images.

10. The method for registering a plurality of images as claimed in claim 9, wherein the calculation of shifts in both the integer and subpixel part is between the plurality of images with a same and/or differing dimensions and/or sizes.

11. The method for registering a plurality of images as claimed in claim 9, wherein the calculation of shifts between the images further comprises the step of obtaining a frequency domain representation of one or more functions.

12. The method for registering a plurality of images as claimed in claim 9, wherein the functions are defined in the frequency domain.

13. The method for registering a plurality of images as claimed in claim 9, wherein the calculation of shifts in the subpixel part further comprises the step of estimating the gradient of the phase data.

14. The method for registering a plurality of images as claimed in claim 9, wherein the estimation of phase gradient comprises methods to reduce phase noise based on estimates of phase error and/or unwrapping phase components and/or removing phase outliers.

15. The method for registering a plurality of images as claimed in claim 9, wherein the phase unwrapping component identifies inappropriately wrapped phase data.

16. The method for registering a plurality of images as claimed in claim 9, wherein the error unwrapping component includes estimates of phase error to unwrap the inappropriately wrapped phase data to obtain a more accurate gradient estimation.

17. The method for registering a plurality of images as claimed in claim 9, wherein the functions have a noise reduction property.

18. The method for registering a plurality of images as claimed in claim 9, wherein the function may further comprise a smoothing differentiator function.

19. The method for registering a plurality of images as claimed in claim 9, wherein the function comprises at least one shape preserving characteristic.

20. The method for registering a plurality of images as claimed in claim 9, wherein the shape preserving characteristic removes noise while minimally changing the underlying true image values.

21. The method for registering a plurality of images as claimed in claim 9, wherein the function may further comprise a differentiator.

22. The method for registering a plurality of images as claimed claim 9, wherein in the frequency domain the frequency response of the differentiator attenuates noise in higher frequencies and preserves the true image values.

23. The method for registering a plurality of images as claimed in claim 9, wherein the differentiator may further comprise a Savitzky-Golay differentiator.

24. The method for registering a plurality of images as claimed in claim 9, wherein the integer shift is used to register two images to within half a pixel.

25. The method for registering a plurality of images as claimed in claim 9, wherein the frequency domain representations of the functions are precalculated.

26. The method for registering a plurality of images as claimed in claim 9, wherein the calculation of shifts in both the integer and subpixel parts in a plurality of images is implemented in hardware.

27. The method for registering a plurality of images as claimed in claim 9, wherein between the plurality of images the method further comprises steps of:
a) applying the function comprising feature extracting characteristics; and
b) obtaining an image characteristic at a plurality of points in each image.

28. The method for registering a plurality of images as claimed in claim 9, wherein the feature extracting characteristics may further comprise denoising and/or smoothing characteristics.

29. The method for registering a plurality of images as claimed in claim 9, wherein the feature-extracting functions are implemented in hardware.

30. An image registration apparatus comprising:
a) an image input means for receiving a plurality of images;
b) an output means for displaying or storing registered images; and
c) a processor for registering the plurality of images;
wherein the processor applies the method as described in claim 1.
